(19) United States
(12) Patent Application Publication
(10) Pub. No.: US 2017/0270254 A1
(43) Pub. Date: Sep. 21, 2017

(54) METHODS AND SYSTEMS FOR QUANTIFYING CLOSENESS OF TWO SETS OF NODES IN A NETWORK

(71) Applicant: Northeastern University, Boston, MA (US)

(72) Inventors: Emre Guney, Guzelbahce-Izmir (TR); Albert-László Barábasi, Brookline, MA (US); Jörg Menche, Vienna (AT)

(21) Appl. No.: 15/461,834

(22) Filed: Mar. 17, 2017

Related U.S. Application Data
(60) Provisional application No. 62/310,564, filed on Mar. 18, 2016.
(60) Provisional application No. 62/449,368, filed on Jan. 23, 2017.

(51) Int. Cl. G06F 19/00

(52) U.S. Cl. CPC G06F 19/326

(57) ABSTRACT

Network-based relative proximity measures according to the present invention quantify the closeness between any two sets of nodes (e.g., drug targets and disease genes in a biological network, or groups of people in a social network). The proximity takes into account the scale-free nature of real-world networks and corrects for degree-bias (i.e., due to incompleteness or study biases) by incorporating various distance definitions between the two sets of nodes and comparison of these distances to those of randomly selected nodes in the network (i.e., the distance relative to random expectation), therefore improving processing of the network data. In brief, the proximity offers a formal framework to characterize the distance between two sets of nodes in the network with key applications in various domains from network pharmacology (e.g., discovering novel uses for existing drugs) to social sciences (e.g., defining similarity between groups of individuals).

### RELATED APPLICATIONS

This application claims the benefit of U.S. Provisional Application No. 62/310,564, filed on Mar. 18, 2016, and U.S. Provisional Application No. 62/449,368, filed on Jan. 23, 2017. The entire teachings of the above applications are incorporated herein by reference.

### GOVERNMENT SUPPORT

This invention was made with government support under Grant No. HG004233 awarded by the National Institutes of Health, Grant No. HL108630 awarded by the National Institutes of Health, Grant No. W911NF-12-C-0028 awarded by the DARPA Social Media in Strategic Communications project, Grant No. W911NF-09-2-0053 awarded by the Network Science Collaborative Technology Alliance sponsored by the US Army Research Laboratory, Grant No. N00014-10-1-0968 awarded by the Office of Naval Research, Grant No. HDTRA1-10-1-0100 awarded by the Defense Threat Reduction Agency, and Grant No. HDTRA1-08-1-0027 awarded by the Defense Threat Reduction Agency. The government has certain rights in the invention.

### BACKGROUND

The emergence of most diseases cannot be explained by single-gene defects, but involves the breakdown of the coordinated function of distinct gene groups. Consequently, to be successful, drug development must shift its focus from individual genes that carry disease-associated mutations towards a network-based perspective of disease mechanisms. We continue to lack, however, a network-based formalism to explore the impact of drugs on proteins known to be perturbed in a disease. Network-based approaches have already offered important insights into the relationship between drugs and diseases. For example, the analysis of targets of US Food and Drug Administration (FDA) approved drugs and disease-related genes in Online Mendelian Inheritance in Man (OMIM) revealed that most drug targets are not closer to the disease genes in the protein interaction network than a randomly selected group of proteins. This suggests that traditional drugs lack selectivity towards the genetic cause of the disease, targeting instead the symptoms of the disease. At the same time, several network-based approaches have focused on predicting novel targets and new uses for existing drugs. Prior approaches rely on target profile similarity, defined by either the number of targets two drugs share or the shortest paths between the drug targets in the interactome. However, the existing literature-derived interaction sets are incomplete and biased towards more studied proteins, like drug targets and disease proteins, shortcomings ignored by the existing network-based methods.

### SUMMARY OF THE INVENTION

Described herein is an unsupervised and unbiased network-based framework to analyze the relationships between drugs and diseases using an interaction network, such as the interactome, which may be represented as a graph G=(V, E) where V is the set of nodes in the network and E is the set of edges connecting nodes of V. Edges can be directed or undirected, and weighted or unweighted. Recent studies have demonstrated that the genes associated with a disease tend to cluster in the same network neighborhood, called a disease module, representing a connected subnetwork within the interactome rich in disease proteins. It is hypothesized that for a drug to be effective for a disease, it must target proteins within or in the immediate vicinity of the corresponding disease module. Thus, described herein is a drug-disease proximity measure that helps quantify the therapeutic effect of drugs, distinguishing non-causative and palliative from causative and effective treatments and offering an unsupervised approach to uncover novel uses for existing drugs. The proximity measure improves processing of the interactome network data by correcting for bias in the interactome.

An example embodiment of the invention is a method of determining a proximity between a first node group and a second node group in an interaction network. The example method includes determining a reachability value between the first node group and the second node group, where the reachability value is determined by averaging a shortest path length from each node in the first node group to a closest node in the second node group. The closest node is a node in the second node group that is closest in network distance to the node in the first node group. The method further includes selecting a first set of additional node groups in the interaction network, where the first set of additional node groups is a plurality of random node groups having nodes with degrees that are similar to the nodes of the first node group. The method further includes selecting a second set of additional node groups in the interaction network, where the second set of additional node groups is a plurality of random node groups having nodes with degrees that are similar to the nodes of the second node group. According to the example method, a distribution of expected reachability values is generated by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. A proximity between the first node group and the second node group is then determined based on (i) the reachability value between the first node group and the second node group, (ii) the mean of the distribution of expected reachability values, and (iii) the standard deviation of the distribution of expected reachability values.

Another example embodiment of the invention is a system for determining a proximity between a first node group and a second node group in an interaction network. The example system includes memory, a hardware processor in communication with the memory, and a control module in communication with the processor. The memory includes the interaction network. The processor is configured to perform a predefined set of operations in response to receiving a corresponding instruction selected from a predefined native instruction set of codes. The control module includes a first set of machine codes selected from the native instruction set for causing the hardware processor to determine and store in the memory a reachability value between the first node group and the second node group, where the reachability value is determined by averaging a shortest path length from each node in the first node group to a closest node in the second node group. The closest node is a node in the second node group that is closest in network distance to the node in the first node group. The control module further includes a second set of machine codes selected from the native instruction set for causing the hardware processor to select and store in the memory a first set of additional node groups in the interaction network, where the first set of additional node groups is a plurality of random node groups having nodes with degrees that are similar to the nodes of the first node group. The control module further includes a third set of machine codes selected from the native instruction set for causing the hardware processor to select and store in the memory a second set of additional node groups in the interaction network, where the second set of additional node groups is a plurality of random node groups having nodes with degrees that are similar to the nodes of the second node group. The control module further includes a fourth set of machine codes selected from the native instruction set for causing the hardware processor to generate and store in the memory a distribution of expected reachability values by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. The control module further includes a fifth set of machine codes selected from the native instruction set for causing the hardware processor to determine and store in the memory the proximity between the first node group and the second node group based on (i) the reachability value between the first node group and the second node group, (ii) the mean of the distribution of expected reachability values, and (iii) the standard deviation of the distribution of expected reachability values.

In some embodiments, the interaction network can include representations of biological interactions between proteins, where the proteins include drug targets and disease proteins. In such embodiments, the first node group can includes representations of drug targets and the second node group can includes representations of disease proteins. In such embodiments, selecting the first set of additional node groups can include selecting representations of drug targets having, according to the interaction network, a number of interactions with other proteins that is similar to a number of interactions that the nodes of the first node group have with other proteins. Further, selecting the second set of additional node groups can include selecting representations of disease proteins having, according to the interaction network, a number of interactions with other proteins that is similar to a number of interactions that the nodes of the second node group have with other proteins.

Based on the determined proximity between the first node group and the second node group, it can be determined (i) whether a drug corresponding to the first node group is therapeutically beneficial to a disease corresponding to the second node group, and/or (ii) whether a drug corresponding to the first node group is effective for palliative treatment of a disease corresponding to the second node group. Further, based on the determined proximity, a new application can be determined for a drug corresponding to the first node group for a disease corresponding to the second node group, and a probable adverse side effect can be determined for a drug corresponding to the first node group. A protein is determined to be likely to induce the adverse side effect if the representation of the protein is significantly associated with drugs having the adverse side effect compared to drugs not having the adverse side effect.

In other example embodiments, the interaction network can include representations of a social network, where the first node group includes representations of a first group of entities in the social network, and the second node group includes representations of a second group of entities in the social network. In such embodiments, a similarity between the first group of entities and the second group of entities can be determined based on the determined proximity between the first node group and the second node group.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a flow diagram illustrating determining a proximity between a first node group and a second node group in an interaction network, according to an example embodiment of the invention.

FIG. 2 is a flow diagram illustrating determining whether a drug is therapeutically beneficial to or is effective for palliative treatment of a disease, according to an example embodiment of the invention.

FIG. 3 is a flow diagram illustrating determining a new application of a drug for a disease, according to an example embodiment of the invention.

FIG. 4 is a flow diagram illustrating determining a probable adverse side effect of a drug, according to an example embodiment of the invention.

FIG. 5 is a flow diagram illustrating determining a similarity between a first group of entities and a second group of entities in a social network, according to an example embodiment of the invention.

FIG. 6 is a block diagram illustrating a system for determining a proximity between a first node group and a second node group in an interaction network, according to an example embodiment of the invention.

FIGS. 7a and 7b illustrate example drug target and degree information. The histogram of FIG. 7a shows numbers of drug targets per drug (the mean is 3.5 and the median is 2) and the histogram of FIG. 7b shows degrees of the targets in the interactome (the mean is 28.6 and the median is 12). The drug target with the highest degree is GRB2 (with 872 interactions).

FIGS. 8a-c illustrate an example network-based drug-disease proximity. FIG. 8a illustrates the closest distance (d_{c}) of a drug T with targets t₁ and t₂ to the proteins s₁, s₂, and s₃ associated with disease S. To measure the relative proximity (z_{c}), we compare the distance d_{c} between T and S to a reference distribution of distances observed if the drug targets and disease proteins are randomly chosen from the interactome. The obtained proximity z_{c} quantifies whether a particular d_{c} is smaller than expected by chance. To account for the heterogeneous degree distribution of the interactome and differences in the number of drug targets and disease proteins, we preserve the number and degrees of the randomized targets and disease proteins. FIG. 8b illustrates the shortest paths between drug targets and disease proteins for two known drug-disease associations: Gliclazide, a T2D drug with two targets and daunorubicin, a drug used for AML that also has two targets in the interactome. The subnetwork shows the shortest paths connecting each drug target to the nearest disease proteins. Proteins are colored with respect to the disease they are associated with: T2D (blue) and AML (red). Drug targets are represented as triangles and colored according to whether they are targets of gliclazide (light blue) and daunorubicin (brown). Blue and red links illustrate the shortest path from the drug targets to the nearest disease proteins (of T2D and AML, respectively). Node size scales with the degree of the node within the subnetwork. In case of multiple disease proteins with the equal shortest path lengths to the target, the disease protein with lowest degree in the interactome is shown. FIG. 8c illustrates the proximity z_{c} of gliclazide and daunorubicin to T2D and AML, indicating low z_{c} for the recommended use of these drugs and high z_{c} for their non-recommended use.

FIGS. 9a and 9b illustrate example prediction performance of the closest method using only a subset of targets or disease proteins. FIG. 9a illustrates AUC values using a subset of disease proteins (seeds), drug targets, and both drug targets and seeds in which the subset is defined by the distance from drug targets to disease proteins (and vice versa) using the closest measure. In subset lᵢ, a disease protein (drug target) is included in the set if it is at most i steps away from the closest drug target (disease protein). FIG. 9b illustrates cumulative probability distribution of closest and shortest distances from drug targets to disease proteins.

FIGS. 10a-d illustrates example proximity versus number and degrees of drug targets and disease proteins. Shown are the proximity of known (blue) and unknown (blue) drug-disease pairs versus the degree of drug targets (FIG. 10a), the number of drug targets (FIG. 10b), the degree of disease proteins (FIG. 10c), and the number of disease proteins (FIG. 10d).

FIGS. 11a-d illustrate assessing prediction performance of proximity. FIG. 11a illustrates Sensitivity and Specificity curves over different proximity values. The proximity has both fair true positive rate (Sensitivity) and true negative rate (Specificity) at z_{c}=−0.15 (the point where the curves meet). FIG. 11b illustrates F-score (harmonic mean of Precision and Sensitivity) versus proximity using all unknown drug-disease associations as negatives. The low f-score is due to the positives constituting a small portion of the all drug-disease associations and the negatives including potential “positives” (repurposing opportunities or drugs worsening the disease condition), giving rise to low Precision. FIG. 11c illustrates F-score versus proximity using 100 groups of randomly sampled unknown drug-disease associations as negatives. Each group contains the same number of negative instances as positive instances (known drug-disease pairs). The blue line shows the average F-score over 100 random groupings. The balanced number of positive and negative instances yields better F-scores. FIG. 11d illustrates AUC values of distance measures using 100 groups of randomly sampled unknown drug-disease associations as negatives. The AUC values are consistent with the values observed using all unknown pairs as negatives, closest measure outperforming the remaining measures. The lines show standard error over 100 different groupings of the unknown drug-disease associations.

FIGS. 12a-e illustrate validating drug-disease proximity. FIG. 12a illustrates AUC for relative proximity, z, calculated using five different distance measures. The closest measure, d_{c}, considers the shortest path length from each target to the closest disease protein, the shortest measure, dₛ averages over all shortest path lengths to the disease proteins. FIG. 12b illustrates average shortest path length between drug targets and disease proteins versus average drug-target degree for known drug-disease pairs. FIG. 12c illustrates drug-disease proximity versus average degree of drug targets for known drug-disease pairs. FIG. 12d illustrates AUC and coverage values for drug similarity-based measures based on the relative proximity between the targets (target proximity), the interactome-based distance between the targets (target PPI), sharing drug targets (target), chemical similarity (chemical), GO terms shared among the targets (GO), common differentially regulated genes in the perturbation profiles of the two drugs in LINCS database (LINCS), and common side effects (side effect). Coverage is defined as the percentage of drug-disease associations for which the method can make predictions. FIG. 12e illustrates numbers of proximal and distant drug-disease pairs among known and unknown drug-disease associations (Fisher's exact test, odds ratio=2.1 and P=5.1×10⁻¹⁴). The unknown drug-disease associations are further categorized based on whether the association is in clinical trials (in trials) or not (not in trials, Fisher's exact test, odds ratio=1.6, P=4.5×10⁻⁹).

FIG. 13 illustrates example known drug-disease associations. For each known drug-disease association, we connect the drug to the disease it is used for, the link style indicating whether the drug is proximal (solid) or distant (dashed) to the disease. The line color represents the number of overlapping proteins between drug targets and disease proteins (0, grey; 6, dark green). Node shape distinguishes drugs (triangles) from diseases (circles). The node size scales with the number of proteins associated with the disease and with the number of targets of the drug.

FIG. 14 is a table illustrating the top ten proximal pathways for donepezil and glyburide.

FIG. 15a-d illustrate drug-disease proximity and efficacy. FIG. 15a illustrates a distribution of RE scores calculated using FDA Adverse Event Reporting System for palliative (n=50), non-palliative (n=219), and off-label (n=133) drug-disease pairs annotated based on DailyMed description. A drug-disease pair is marked palliative if the indication in DailyMed referred to the non-causative use of the drug in that disease and non-palliative otherwise. If the indication is not in the label, then it is marked as off-label. The median within each group is shown as a black dot. The contours represent the probability density of the data points based on kernel density. Palliative uses have lower RE scores compared with non-palliative (one-sided Mann-Whitney U test=7.3×10⁻⁵) and off-label uses (P=7.6×10⁻⁴). FIG. 15b illustrates a distribution of drug-disease proximity for palliative, non-palliative, and off-label drug-disease pairs. The palliative uses have higher proximity values (P=4.0×10⁻⁵ and P=0.02 compared with non-palliative and off-label uses, respectively). FIG. 15c illustrates a distribution of RE for proximal (n=237) versus distant (n=165) drug-disease pairs. The proximal drug-disease pairs have higher RE scores (P=0.04). The top panel of FIG. 15d illustrates, for each disease, the number of known drugs that are proximal to the disease (dark blue) compared with the number of distant drugs (light brown). The ratio of proximal drugs to all drugs is shown in red. The plot is split into two regions horizontally based on the ratio of proximal drugs: the diseases for which (i) more than half of the drugs are proximal (yellow background) and (ii) the rest (grey background). The bottom panel of FIG. 15d illustrates RE scores of drugs for each disease as red lines and a curve corresponding to the probability density estimate. The median within each disease is drawn by a solid line, whereas the median RE over all the diseases is drawn as a dashed line. NA (not applicable) indicates that data for the corresponding disease is not available (that is, fewer than 10 adverse reports). Note that for diseases in which most known drugs are proximal to the disease, the efficacy is also higher on average compared with the rest.

FIG. 16 illustrates example anatomic therapeutic chemical (ATC) classification of proximal and distant drug-disease pairs. The number of proximal (dark blue) and distant (light brown) drugs in each ATC category among known drug-disease associations. The ATC codes are sorted in descending order with respect to the difference of the number of proximal and distant drugs.

FIG. 17 is a table illustrating example proximity values for several repurposed and failed drugs.

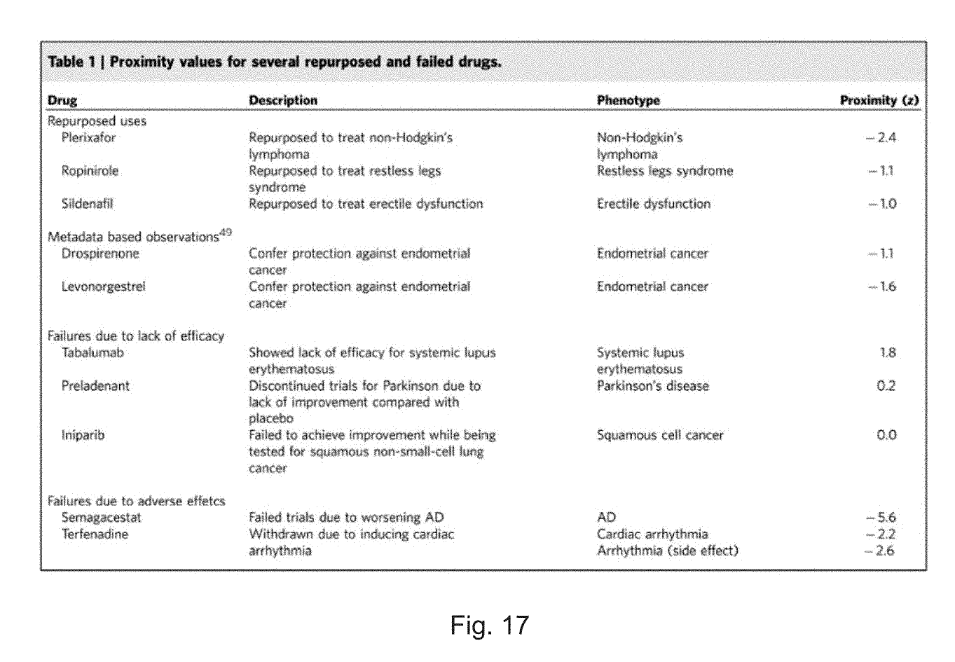

FIG. 18 is a table illustrating example prediction performance of drug-disease proximity (z_{c}) using various data sets.

FIG. 19 illustrates a computer network or similar digital processing environment in which embodiments of the invention may be implemented.

FIG. 20 is a diagram of an example internal structure of a computer in the computer system of FIG. 19.

### DETAILED DESCRIPTION OF THE INVENTION

A description of example embodiments of the invention follows.

The increasing cost of drug development together with a significant drop in the number of new drug approvals raises the need for innovative approaches for target identification and efficacy prediction. Here, we take advantage of our increasing understanding of the network-based origins of diseases to introduce a drug-disease proximity measure that quantifies the interplay between drugs targets and diseases. By correcting for the known biases of the interactome, proximity helps us uncover the therapeutic effect of drugs, as well as to distinguish palliative from effective treatments. Our analysis of 238 drugs used in 78 diseases indicates that the therapeutic effect of drugs is localized in a small network neighborhood of the disease genes and highlights efficacy issues for drugs used in Parkinson and several inflammatory disorders. Finally, network-based proximity allows us to predict novel drug-disease associations that offer unprecedented opportunities for drug repurposing and the detection of adverse effects.

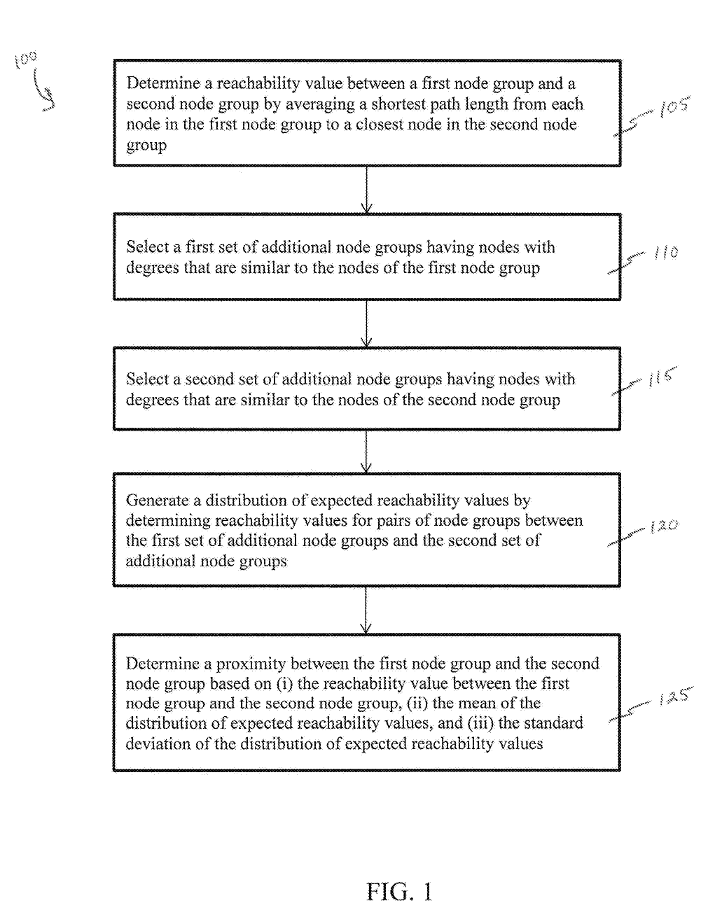

FIG. 1 is a flow diagram 100 illustrating determining a proximity between a first node group and a second node group in an interaction network, according to an example embodiment of the invention. The example method 100 includes determining (105) a reachability value between the first node group and the second node group, where the reachability value is determined by averaging a shortest path length from each node in the first node group to a closest node in the second node group. The closest node is a node in the second node group that is closest in network distance to the node in the first node group. The method further includes selecting (110) a first set of additional node groups in the interaction network, where the first set of additional node groups is a plurality of random node groups having nodes with degrees that are similar to the nodes of the first node group. The method further includes selecting (115) a second set of additional node groups in the interaction network, where the second set of additional node groups is a plurality of random node groups having nodes with degrees that are similar to the nodes of the second node group. According to the example method, a distribution of expected reachability values is generated (120) by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. A proximity between the first node group and the second node group is then determined (125) based on (i) the reachability value between the first node group and the second node group, (ii) the mean of the distribution of expected reachability values, and (iii) the standard deviation of the distribution of expected reachability values.

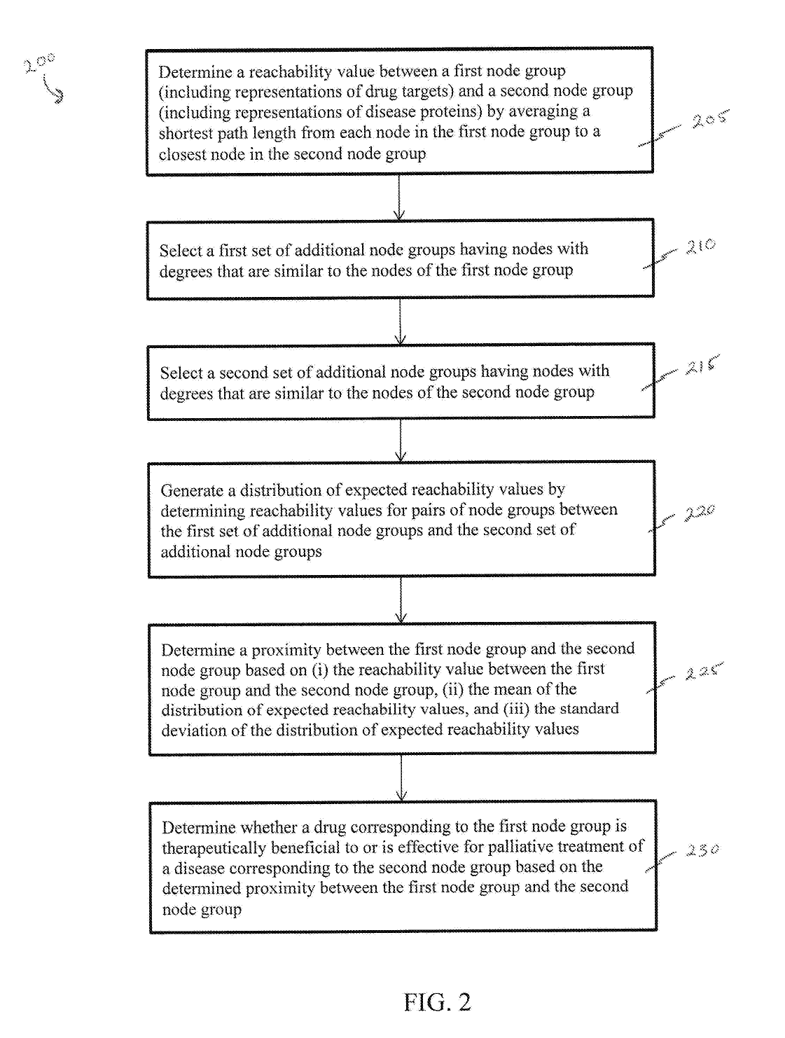

FIG. 2 is a flow diagram 200 illustrating determining whether a drug is therapeutically beneficial to or is effective for palliative treatment of a disease, according to an example embodiment of the invention. According to the example embodiment, the interaction network includes representations of biological interactions between proteins, where the proteins include drug targets and disease proteins. The example method 200 includes determining (205) a reachability value between a first node group (including representations of drug targets) and a second node group (including representations of disease proteins), where the reachability value is determined by averaging a shortest path length from each node in the first node group to a closest node in the second node group. The closest node is a node in the second node group that is closest in network distance to the node in the first node group. The method further includes selecting (210) a first set of additional node groups in the interaction network, where the first set of additional node groups is a plurality of random node groups having nodes with degrees that are similar to the nodes of the first node group. The method further includes selecting (215) a second set of additional node groups in the interaction network, where the second set of additional node groups is a plurality of random node groups having nodes with degrees that are similar to the nodes of the second node group. According to the example method, a distribution of expected reachability values is generated (220) by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. A proximity between the first node group and the second node group is then determined (225) based on (i) the reachability value between the first node group and the second node group, (ii) the mean of the distribution of expected reachability values, and (iii) the standard deviation of the distribution of expected reachability values. Based on the determined proximity between the first node group and the second node group, it is determined (230) whether a drug corresponding to the first node group is therapeutically beneficial to a disease corresponding to the second node group, and/or whether a drug corresponding to the first node group is effective for palliative treatment of a disease corresponding to the second node group.

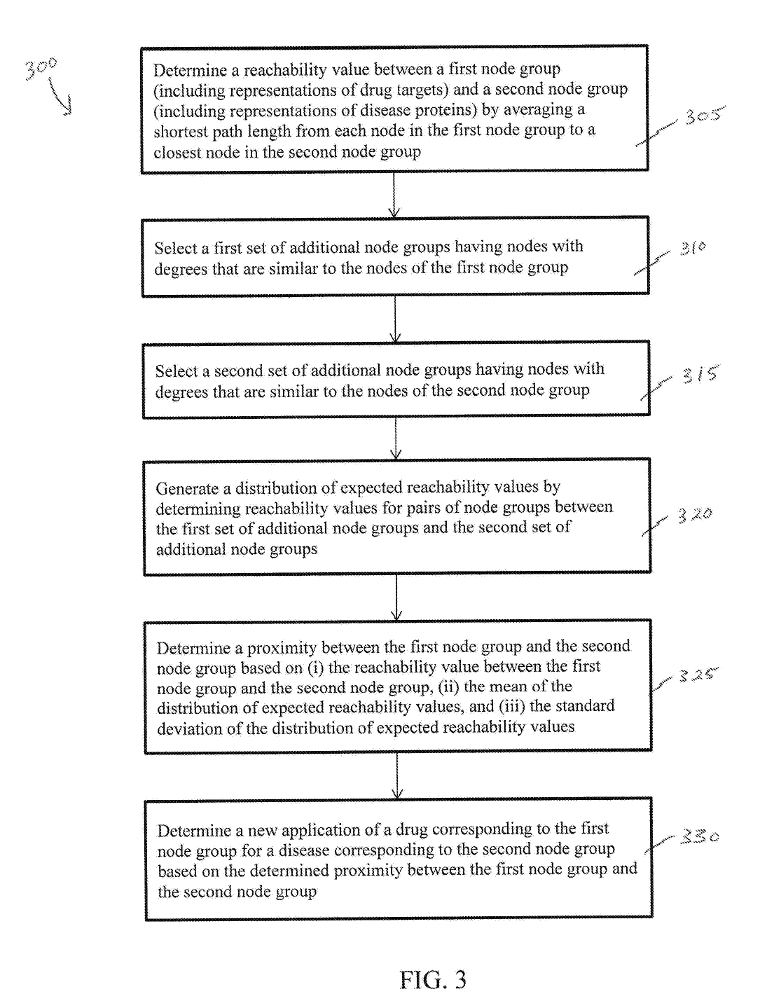

FIG. 3 is a flow diagram 300 illustrating determining a new application of a drug for a disease, according to an example embodiment of the invention. According to the example embodiment, the interaction network includes representations of biological interactions between proteins, where the proteins include drug targets and disease proteins. The example method 300 includes determining (305) a reachability value between a first node group (including representations of drug targets) and a second node group (including representations of disease proteins), where the reachability value is determined by averaging a shortest path length from each node in the first node group to a closest node in the second node group. The closest node is a node in the second node group that is closest in network distance to the node in the first node group. The method further includes selecting (310) a first set of additional node groups in the interaction network, where the first set of additional node groups is a plurality of random node groups having nodes with degrees that are similar to the nodes of the first node group. The method further includes selecting (315) a second set of additional node groups in the interaction network, where the second set of additional node groups is a plurality of random node groups having nodes with degrees that are similar to the nodes of the second node group. According to the example method, a distribution of expected reachability values is generated (320) by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. A proximity between the first node group and the second node group is then determined (325) based on (i) the reachability value between the first node group and the second node group, (ii) the mean of the distribution of expected reachability values, and (iii) the standard deviation of the distribution of expected reachability values. Based on the determined proximity between the first node group and the second node group, a new application is determined (330) for a drug corresponding to the first node group for a disease corresponding to the second node group.

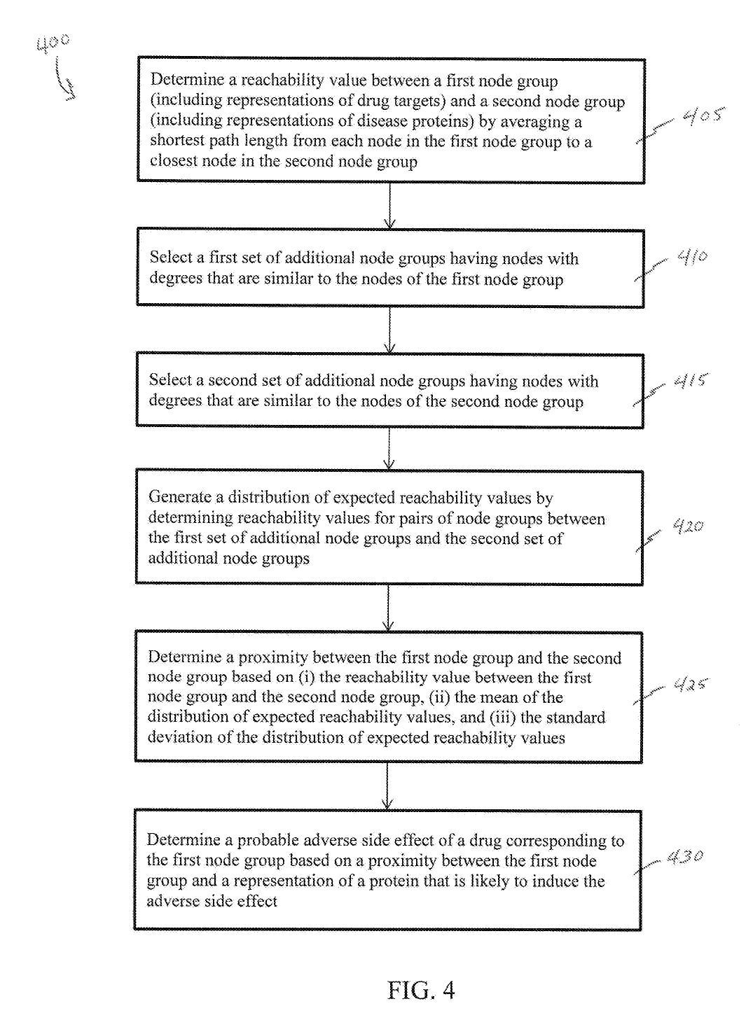

FIG. 4 is a flow diagram 400 illustrating determining a probable adverse side effect of a drug, according to an example embodiment of the invention. According to the example embodiment, the interaction network includes representations of biological interactions between proteins, where the proteins include drug targets and disease proteins. The example method 400 includes determining (405) a reachability value between a first node group (including representations of drug targets) and a second node group (including representations of disease proteins), where the reachability value is determined by averaging a shortest path length from each node in the first node group to a closest node in the second node group. The closest node is a node in the second node group that is closest in network distance to the node in the first node group. The method further includes selecting (410) a first set of additional node groups in the interaction network, where the first set of additional node groups is a plurality of random node groups having nodes with degrees that are similar to the nodes of the first node group. The method further includes selecting (415) a second set of additional node groups in the interaction network, where the second set of additional node groups is a plurality of random node groups having nodes with degrees that are similar to the nodes of the second node group. According to the example method, a distribution of expected reachability values is generated (420) by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. A proximity between the first node group and the second node group is then determined (425) based on (i) the reachability value between the first node group and the second node group, (ii) the mean of the distribution of expected reachability values, and (iii) the standard deviation of the distribution of expected reachability values. Based on the determined proximity between the first node group and the second node group, a probable adverse side effect is determined (430) for a drug corresponding to the first node group. A protein is determined to be likely to induce the adverse side effect if the representation of the protein is significantly associated with drugs having the adverse side effect compared to drugs not having the adverse side effect.

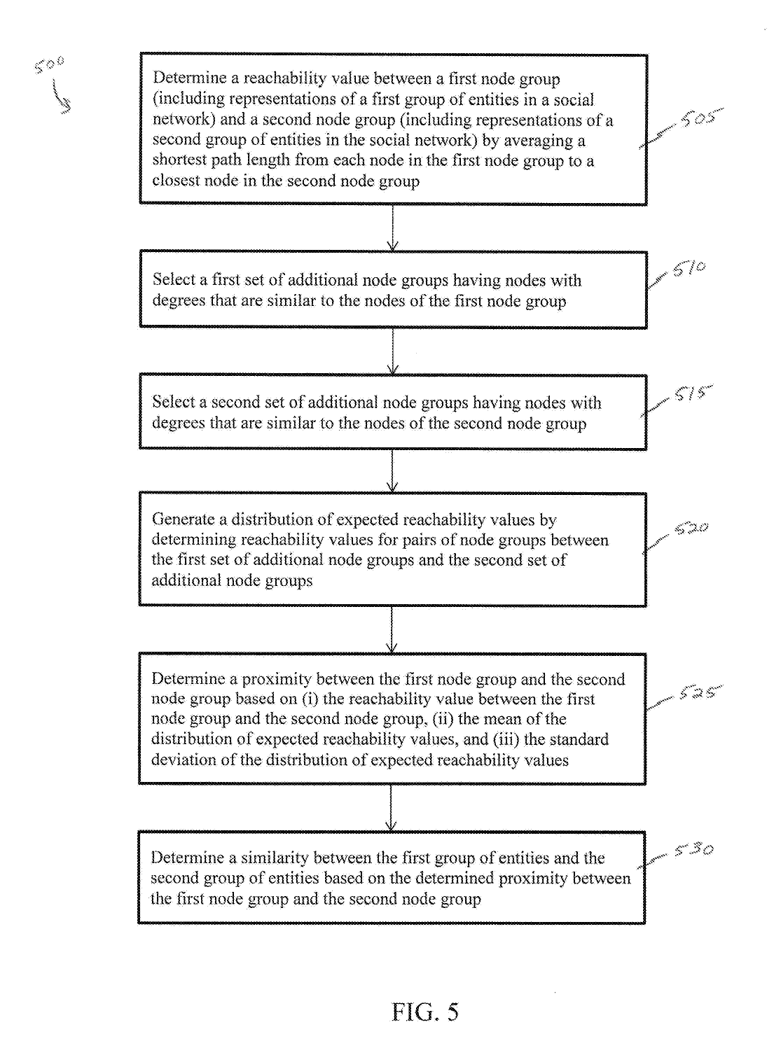

FIG. 5 is a flow diagram 500 illustrating determining a similarity between a first group of entities and a second group of entities in a social network, according to an example embodiment of the invention. According to the example embodiment, the interaction network includes representations of a social network. The example method 500 includes determining (505) a reachability value between a first node group (including representations of a first group of entities in the social network) and a second node group (including representations of a second group of entities in the social network), where the reachability value is determined by averaging a shortest path length from each node in the first node group to a closest node in the second node group. The closest node is a node in the second node group that is closest in network distance to the node in the first node group. The method further includes selecting (510) a first set of additional node groups in the interaction network, where the first set of additional node groups is a plurality of random node groups having nodes with degrees that are similar to the nodes of the first node group. The method further includes selecting (515) a second set of additional node groups in the interaction network, where the second set of additional node groups is a plurality of random node groups having nodes with degrees that are similar to the nodes of the second node group. According to the example method, a distribution of expected reachability values is generated (520) by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. A proximity between the first node group and the second node group is then determined (525) based on (i) the reachability value between the first node group and the second node group, (ii) the mean of the distribution of expected reachability values, and (iii) the standard deviation of the distribution of expected reachability values. Based on the determined proximity between the first node group and the second node group, a similarity is determined (530) between the first group of entities and the second group of entities.

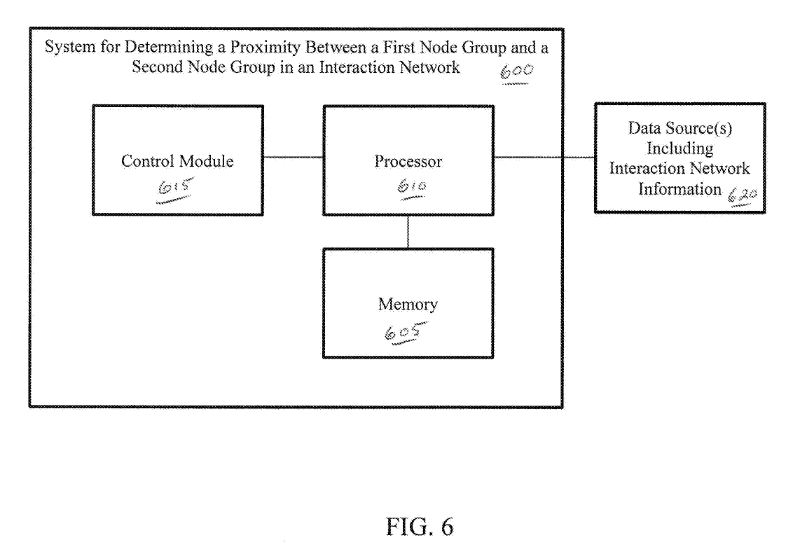

FIG. 6 is a block diagram illustrating a system 600 for determining a proximity between a first node group and a second node group in an interaction network, according to an example embodiment of the invention. The example system 600 includes memory 605, a hardware processor 610 in communication with the memory 605, and a control module 615 in communication with the processor 610. The memory 605 includes the interaction network (e.g., a copy of or representation of the interaction network). The processor 610 is configured to perform a predefined set of operations in response to receiving a corresponding instruction selected from a predefined native instruction set of codes. The control module 615 includes a first set of machine codes selected from the native instruction set for causing the hardware processor 610 to determine and store in the memory 605 a reachability value between the first node group and the second node group, where the reachability value is determined by averaging a shortest path length from each node in the first node group to a closest node in the second node group. The closest node is a node in the second node group that is closest in network distance to the node in the first node group. The control module 615 further includes a second set of machine codes selected from the native instruction set for causing the hardware processor 610 to select and store in the memory 605 a first set of additional node groups in the interaction network, where the first set of additional node groups is a plurality of random node groups having nodes with degrees that are similar to the nodes of the first node group. The control module 615 further includes a third set of machine codes selected from the native instruction set for causing the hardware processor 610 to select and store in the memory 605 a second set of additional node groups in the interaction network, where the second set of additional node groups is a plurality of random node groups having nodes with degrees that are similar to the nodes of the second node group. The control module 615 further includes a fourth set of machine codes selected from the native instruction set for causing the hardware processor 610 to generate and store in the memory 605 a distribution of expected reachability values by determining reachability values for pairs of node groups between the first set of additional node groups and the second set of additional node groups, where each reachability value is determined by averaging a shortest path length from each node in one of the node groups of the first set of additional node groups to a closest node in a corresponding node group of the second set of additional node groups. The control module 615 further includes a fifth set of machine codes selected from the native instruction set for causing the hardware processor 610 to determine and store in the memory 605 the proximity between the first node group and the second node group based on (i) the reachability value between the first node group and the second node group, (ii) the mean of the distribution of expected reachability values, and (iii) the standard deviation of the distribution of expected reachability values.

The following describes example embodiments of a network-based relative proximity measure according to the present invention to quantify the closeness between any two sets of nodes (e.g., drug targets and disease genes in a biological network, or groups of people in a social network). The proximity takes into account the scale-free nature of real-world networks and corrects for degree-bias (i.e., due to incompleteness or study biases) by incorporating various distance definitions between the two sets of nodes and comparison of these distances to those of randomly selected nodes in the network (i.e., the distance relative to random expectation). In brief, the proximity offers a formal framework to characterize the distance between two sets of nodes in the network with key applications in various domains from network pharmacology (e.g., discovering novel uses for existing drugs) to social sciences (e.g., defining similarity between groups of individuals).

The example embodiments calculate and compare distances between groups of nodes to randomly chosen nodes in the network by matching the degrees of nodes. The methods are, therefore, unbiased with respect to underlying network and can be used to define relatedness of two groups of nodes in the network in an unsupervised manner. The methods can be used, for example, to identify novel uses for FDA approved drugs (drug repurposing).

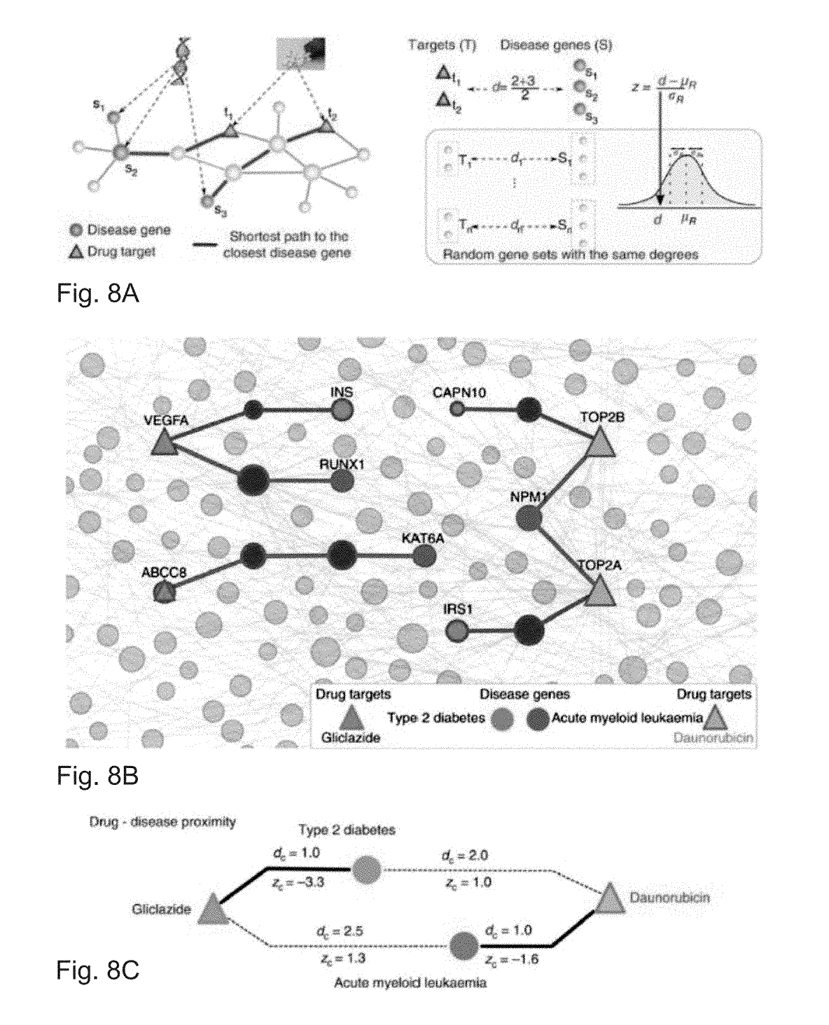

An example method embodiment of the invention takes two groups of nodes (T and S) and an interaction network (G) as inputs. The proximity between T and S is calculated as follows (see FIG. 8 for an example illustration):

(1) Calculate an observed “reachability”, d, from T to S in G by averaging the shortest path from all the nodes in T to the closest node in S.

(2) Choose random groups of nodes T′ and S′ to match the nodes in T and S, respectively (where the nodes in T′ and S′ have similar degrees to the nodes in T and S). Repeat this step n times.

(3) Calculate the reachability values between each of the n random groupings (Ti′ and Si′, i=1, 2, 3, . . . , n), to generate a distribution of “expected” reachability values, and calculate the mean and standard deviation of the distribution.

(4) Compute the proximity between T and S as the z-score calculated using the observed reachability and the mean and standard deviation of the expected reachability value distribution.

Results of Example Studies

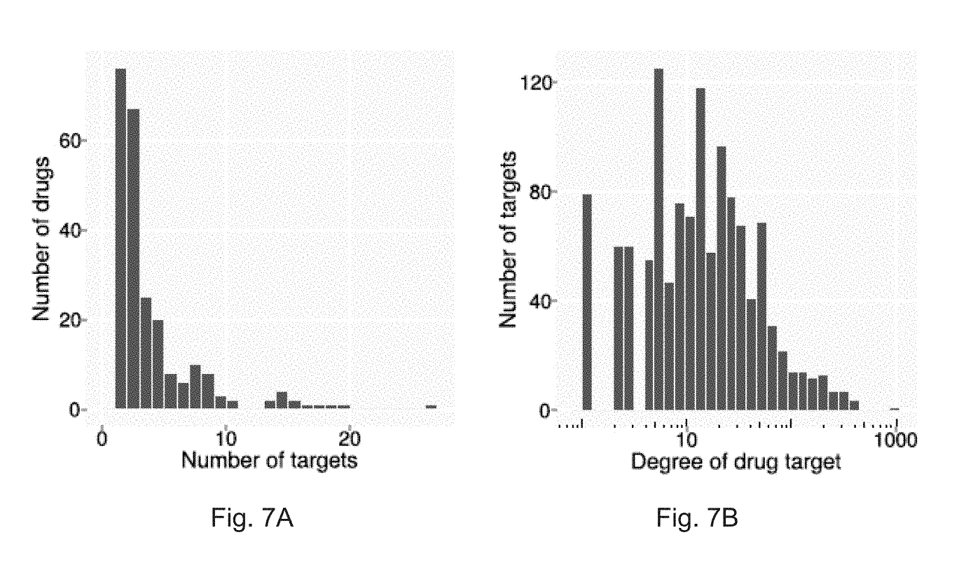

Proximity between drugs and diseases in the interactome. We start with all 1,489 diseases defined by Medical Subject Headings (MeSH) compiled in a recent study. For each disease, we retrieve associated genes from the OMIM database and the GWAS catalog. We focus on the diseases with at least 20 disease-associated genes in the human interactome such that the diseases are genetically well characterized and are likely to induce a module in the interactome. We gather the drug-target information on FDA approved drugs from DrugBank and the indication information (the diseases the drug is used for) from the medication-indication resource high-precision subset (MEDI-HPS), which is then filtered by strong literature evidence using Metab2MeSH to represent a high-confidence drug-disease association data set. In total, we identify 238 drugs whose indication matches 78 diseases and whose targets are in the human interactome containing 141,150 interactions between 13,329 proteins. Several of these drugs are recommended for more than one disease, resulting in 402 drug-disease associations between 238 drugs and 78 diseases. The average number of targets in the network per drug is n_{target}=3.5 and the mean degree of the targets is k_{target}=28.6, larger than the interactome's average degree k=21.2 (see FIG. 7), a difference that we attribute to the literature bias towards drug targets.

To investigate the relationship between drug targets and disease proteins, we develop a relative proximity measure that quantifies the network-based relationship between drugs and disease proteins (proteins encoded by genes associated with the disease). For this, for each drug-disease pair, we compare the network-based distance d between the known drug targets and the disease proteins to the expected distances d_{rand} between them if the target-disease protein sets are chosen at random within the interactome. We initially focus on two distance measures d to determine the relative proximity: (i) The most straightforward measure is the average shortest path length, dₛ, between all targets of a drug and the proteins involved in the same disease; (ii) Acknowledging that a drug may not necessarily target all disease proteins, we also use closest measure, d_{c}, representing the average shortest path length between the drug's targets and the nearest disease protein. In this case, we have d_{c}=0 only if all drug targets are also disease proteins. For both distance measures, dₛ and d_{c}, the corresponding relative proximity zₛ and z_{c} captures the statistical significance (z-score, z=(d−u)/σ) of the observed target-disease protein distance compared with the respective random expectation. FIG. 8a illustrates the calculation of the relative proximity z_{c} using the closest measure d_{c}, which, as we show later, outperforms other distance measures.

To demonstrate the utility of the relative proximity, FIG. 8b shows the shortest paths between drug targets and disease proteins for two known drug-disease associations: Gliclazide-type 2 diabetes (T2D) and daunorubicin-acute myeloid leukaemia (AML). Gliclazide binds to ATP-binding cassette sub-family C member 8 (ABCC8) and vascular endothelial growth factor A and stimulates pancreatic beta-islet cells to release insulin. ABCC8 is a known T2D gene (MIM:600509) and there is at least one protein associated with T2D within two steps of vascular endothelial growth factor A's neighborhood corresponding to an average distance of d_{c}=1.0 between the drug and the disease using the closest measure. The relative proximity between the drug and the disease is z_{c}=−3.3, suggesting that the targets of gliclazide are closer to the T2D proteins than expected by chance (see FIG. 8c). Similarly, the relative proximity of daunorubicin, an anthracycline aminoglycoside inhibiting the DNA topoisomerase II (TOP2A and TOP2B), to AML is z_{c}=−1.6, offering network-based support for daunorubicin's therapeutic effect in AML. As a negative control, we measure the relative proximity of gliclazide to AML and daunorubicin to T2D, pairings whose efficacies are not known. In both cases, the disease proteins and drug targets are not closer than expected for randomly selected protein sets (z_{c}=1.3 and z_{c}=1.0, respectively), suggesting that these drugs do not target the disease module of other diseases, but they are specific to the module of the disease they are recommended for.

To generalize these findings, we group all possible 18,564 drug-disease associations between 238 drugs and 78 diseases into 402 known (validated) drug-disease associations that are reported in the literature (like gliclazide and T2D) and the remaining 18,162 unknown drug-disease associations that are not known (and are unlikely) to be effective. For example, we do not expect gliclazide to be more effective on AML, than any other randomly chosen drug. Yet, a few of the 18,162 unknown drug-disease pairs may correspond to effective treatments, representing novel candidates for drug repurposing, challenging us to identify which ones. Consistent with previous observations, only in 62 of the 402 known drug-disease associations (15.4%), drug-target coincides with a disease protein. On the other hand, in 490 of 18,162 unknown drug-disease pairs (2.7%) the drug targets are known disease proteins, but not associated with the drug's actual disease indication. Although in both classes (known and unknown), the overlap between drug targets and disease proteins is low, the much higher ratio among known drug-disease associations (Fisher's exact test, odds ratio=6.6, two-sided P=5.2×10⁻²⁷) suggests that direct targeting of known disease proteins is a rare but important therapeutic component in disease treatment.

Drugs Target the Local Neighborhood of the Disease Proteins

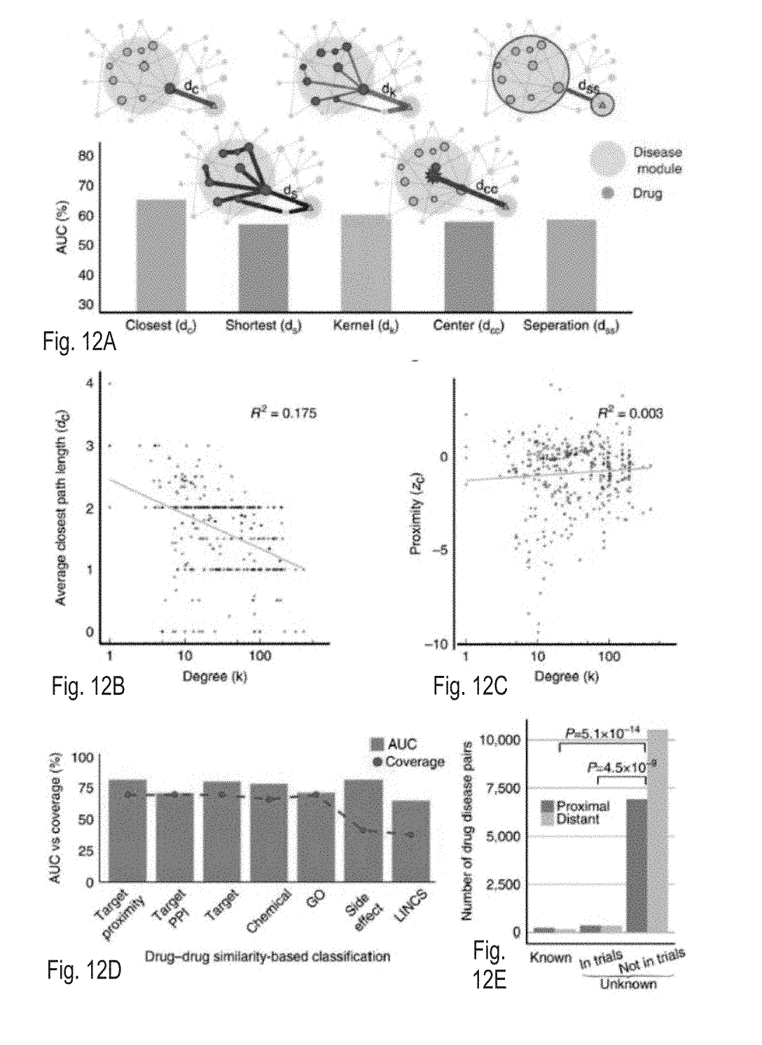

We first test how well relative proximity discriminates the 402 known drug-disease pairs from the 18,162 unknown drug-disease pairs by comparing the area under Receiver Operating Characteristic (ROC) curve (AUC) for different distance measures. In addition to the closest (d_{c}) and shortest (dₛ) measures discussed above, we measure relative proximity between a drug and a disease using three other network-based distance measures: (i) the kernel measure, dₖ, which downweights longer paths using an exponential penalty, (ii) the centre measure, d_{cc}, which is the shortest path length between the drug targets and the disease protein with the largest closeness centrality among the disease proteins, (iii) the separation measure, dₛₛ, that records the sum of the average distance between drug targets and disease proteins using the closest measure and subtracts it from the average shortest distance between drug targets and disease proteins. We find that the relative proximity defined by the closest measure d_{c} (AUCz_{c}=66%) offers the best discrimination among the known and unknown drug-disease pairs (see FIG. 12a), outperforming the shortest (AUCzₛ=58%, DeLong's AUC difference test P=5.1×10⁻⁷), the kernel (AUCzₖ=61%, P=4.7×10⁴), the centre (AUCz_{cc}=58%, P=1.2×10⁻⁵), and the separation (AUCzₛₛ=59%, P=2.1×10⁻⁴) measures.

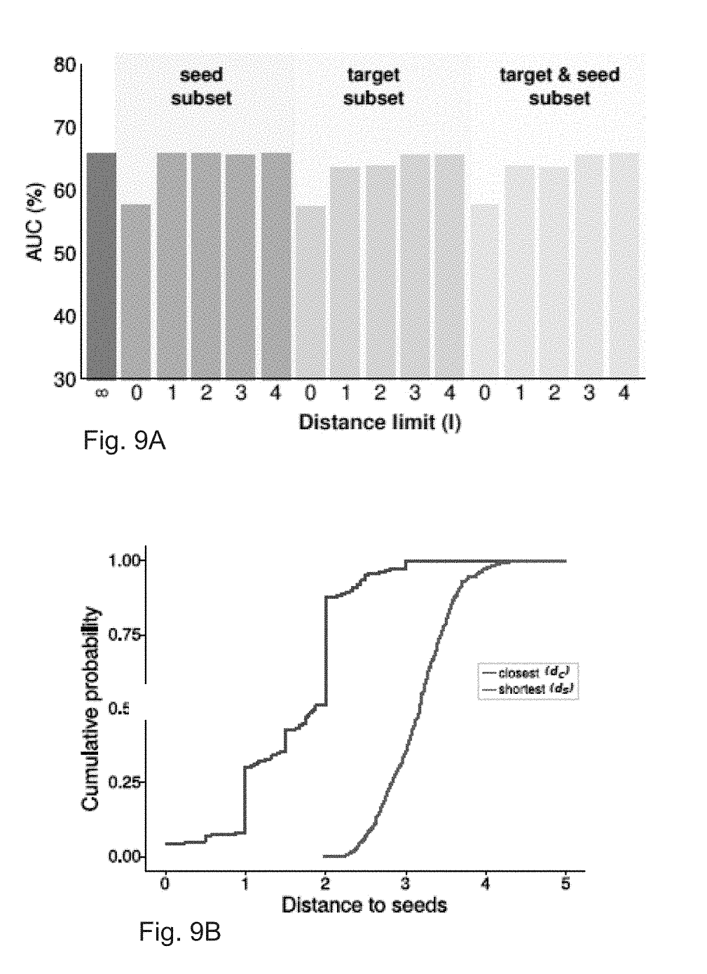

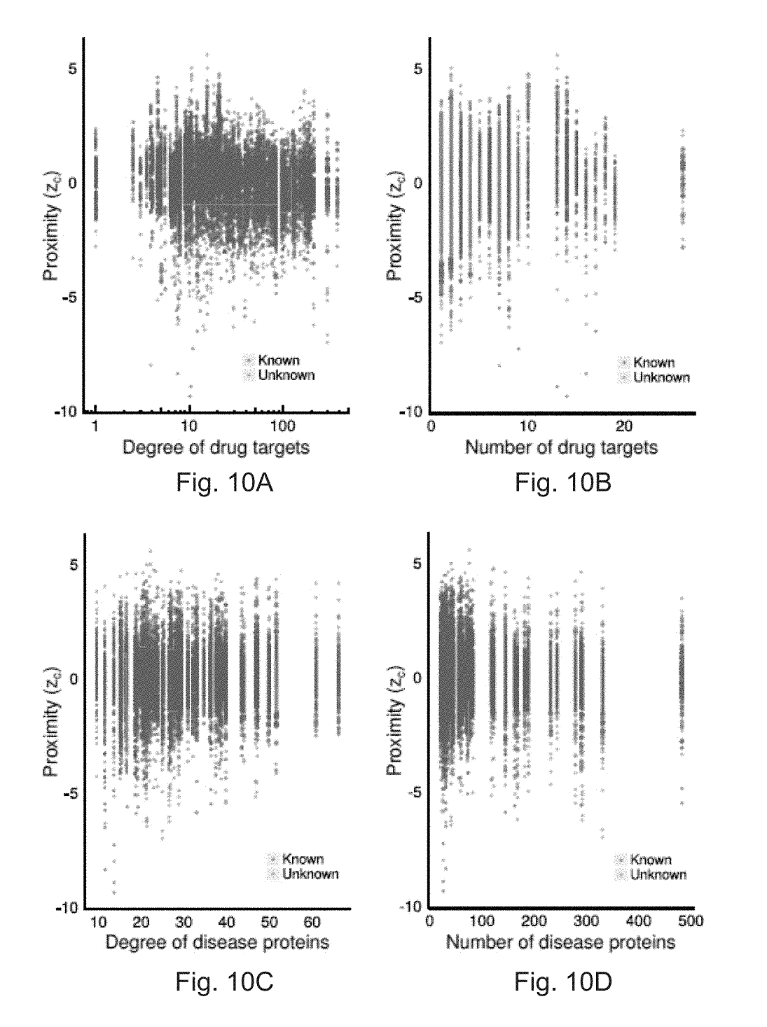

The superior performance of the closest measure suggests that drug targets do not have to be close to all proteins implicated in a disease. That is, drugs tend to affect a subset of the disease module rather than targeting the disease module as a whole. Indeed, we find that most drugs exert their therapeutic effect on disease proteins that are at most two links away (see FIG. 9 and Supplementary Note 1, below). Note also that relative proximity corrects for the biases of the traditional shortest path-based measures: the closest distance is significantly anti-correlated with the number of interactions the target proteins have (Spearman's rank correlation coefficient p=−0.46, P=8.6×10⁻²³), whereas relative proximity associated with the closest distance show no correlation with degree (p=−0.01, P=0.84, FIG. 12b, FIG. 12c, FIG. 10, and Supplementary Note 2, below).

Proximity Improves on Existing Drug Repurposing Approaches

The increasing interest in reusing existing drugs for novel therapies has recently given rise to various approaches that aim to identify candidate drugs with similar characteristics to known drugs used in a disease. We use interactome-based drug-disease proximity to define similarity between two drugs and compare it with existing approaches defining similarity through (i) the shortest path distance between their targets in the interactome, (ii) common targets, (iii) chemical similarity, (iv) Gene Ontology (GO) terms shared among their targets, (v) common differentially regulated genes in the perturbation profiles of the two drugs in Library of Integrated Network-based Cellular Signatures (LINCS) database (lincsproject.org) and (vi) common side effects given in Side Effect Resource (SIDER) (see Supplementary Note 3). We find that proximity-based similarity discriminates known drug-disease pairs from unknown drug-disease pairs better than most of the existing similarity-based methods (AUC_{targetproximity}=81%, FIG. 12d). The increase in the AUC is significant compared with using shortest path-based similarity (AUC_{targetPPI}=71%, P=7.4×10⁻¹⁴), chemical similarity (AUC_{chemical}=78%, P=0.03), functional similarity (AUC_{GO}=71%, P=4.8×10⁻¹⁸) and expression profile similarity (AUC_{LINCS}=65%, P=2.8×10⁻²⁰). Proximity-based similarity definition outperforms the similarity definition based on shared targets, yet the improvement is not significant (AUC_{target}=80%, P=0.12). Despite having comparable accuracy (AUC_{sideeffect}=81%, P=0.56), the side effect similarity-based method is only applicable to less than half of the drug-disease pairs.

Although similarity-based methods are powerful in discriminating known drug-disease pairs from unknown drug-disease pairs, they have two main drawbacks: (i) these methods rely on the existing knowledge of drug and disease information, making them prone to overfitting and (ii) they fail to provide insights on the drug mechanism of action. Gene expression profile consistency based approaches aim to overcome these limitations by investigating correlations between the expression signatures of drug perturbations and the expression profiles in diseases. We use the drug and disease signatures in drug versus disease (DvD) resource and calculate a Kolomgorov-Smirnov statistic-based enrichment score for the 1,980 (95 known, 1,885 unknown) drug-disease pairs that are in the DvD data set. We show that, proximity yields better accuracy than expression correlation-based prediction of drug-disease associations (AUC_{proximity}=63% versus AUC_{DvD}=53%, P=0.01, Supplementary Note 4). Though, the poor performance of the expression based approach is surprising, it is consistent with a recent systematic analysis reporting similar AUC values. Therefore, proximity provides an alternative to the drug similarity and gene expression based repurposing approaches that can offer an interactome-based explanation towards the drug's effect on a disease. Their combination, though, could offer increased predictive power, given the orthogonal nature of the information the two classes of methods use.

Proximity is a Good Proxy of Therapeutic Effect

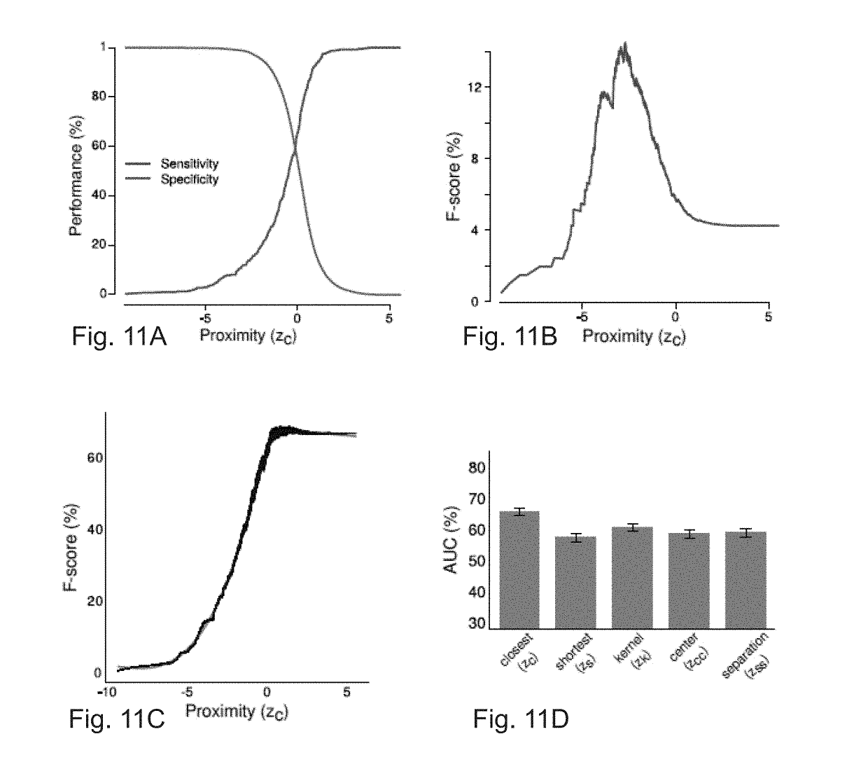

The effectiveness of proximity as an unbiased measure of drug-disease relatedness prompts us to ask: Are drugs (drug targets) that are closer to the disease (disease proteins) more effective than distant drugs? To answer this, we define a drug to be proximal to a disease if its proximity follows z_{c}≦−0.15, and distant otherwise. This threshold is chosen as it offers good coverage of known drug-disease associations and few false positives (see FIG. 11 and Supplementary Note 5, below), helping us arrive at several key findings:

(i) Known drugs are more proximal to their disease: For 237 of the 402 known drug-disease associations (59%), the drugs are proximal to the disease they are indicated for (see FIG. 12e). At the same time, drugs are proximal in 7,276 of the 18,162 unknown drug-disease associations (40%), representing numerous potential candidates for drug repurposing. The ratio of known drug-disease associations among proximal drug-disease associations compared with the same ratio among distant drug-disease associations is statistically highly significant (Fisher's exact test, odds ratio=2.1, P=5.1×10⁻¹⁴). In other words, a drug whose targets are proximal to a disease is twice more likely to be effective for that disease than a distant drug.

(ii) Proximal drugs are more likely to be tested in clinical trials: The proximal but currently unknown drug-disease pairs are significantly over-represented in clinical trials compared with the distant unknown drug-disease pairs (353 proximal versus 341 distant drug-disease pairs, odds ratio=1.6, P=4.5×10⁻⁹).

(iii) Most known drugs are not exclusive: We examine the enrichment of known drug-disease associations among significantly proximal (that is, z_{c}≦−2) drug-disease pairs and observe a significant increase in the ratio of known drug-disease pairs compared with unknown pairs (odds ratio=5.2, P=2.6×10⁻²⁷). However, only 79 out of 402 known drug-disease pairs are significantly proximal to each other. Therefore, a drug should be sufficiently selective (that is, proximal to the disease) to have therapeutic effect but not necessarily exclusive (significantly proximal to the disease).

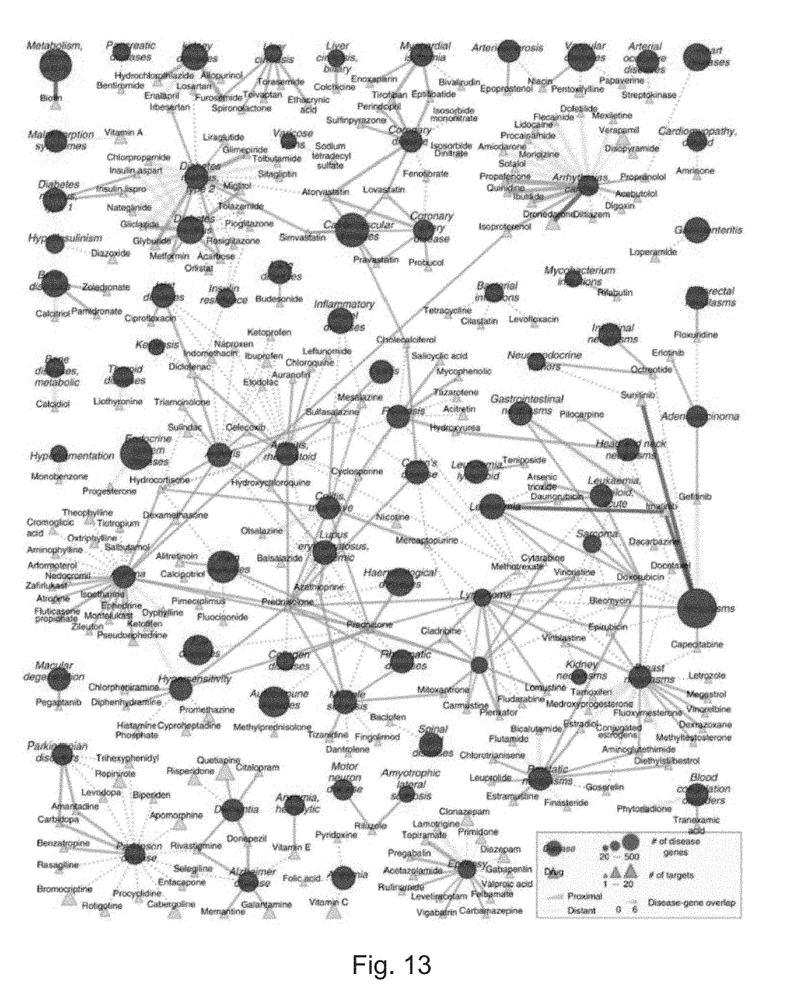

(iv) Proximity can highlight non-trivial associations: We find that in 18 known drug-disease pairs in which all the drug targets are also disease proteins, the drugs are proximal to the disease as one would expect. On the other hand, in 44 pairs for which at least one but not all of the drug targets are disease proteins, all the drugs are proximal to the disease with the only exception of disopyramide, a cardiac arrhythmia drug (see FIG. 13). In 176 of the remaining 340 known drug-disease associations for which the drug targets do not coincide with any of the disease proteins, the drug targets are proximal to the disease, indicating that the interactome can highlight non-obvious drug-disease associations in which the drug does not directly target known disease proteins.

Pinpointing Palliative Treatments Using Proximity

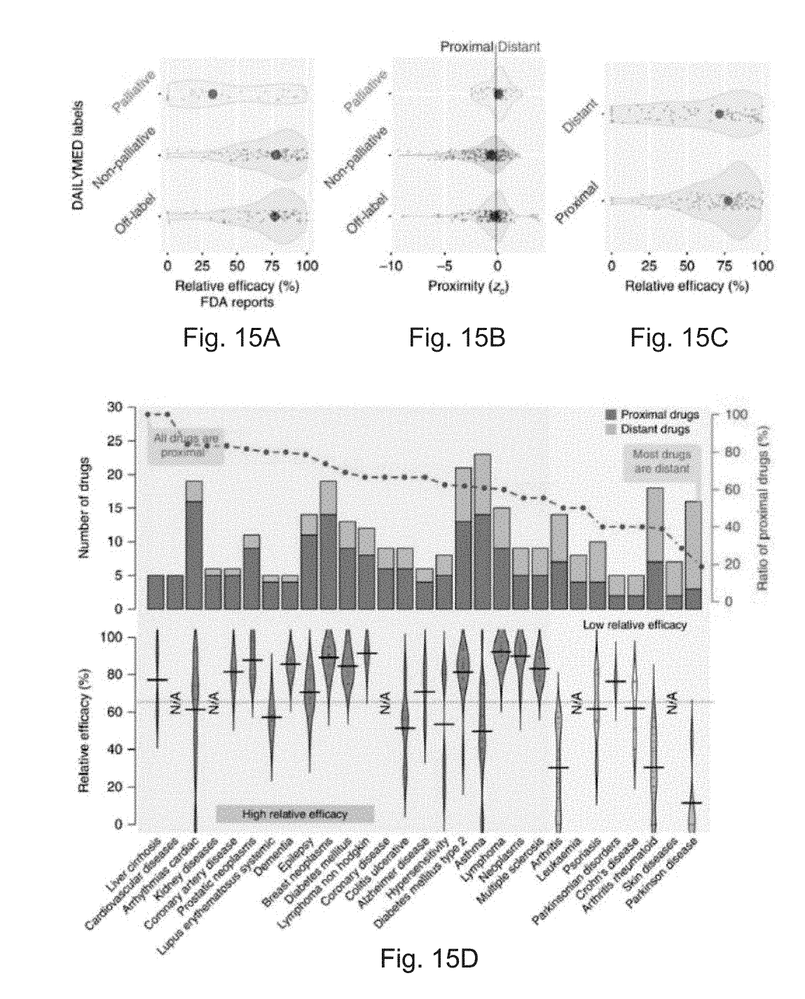

Intriguingly, for 165 known drug-disease pairs, the drugs are distant to the disease they are recommended for, indicating that the interactome is unable to explain the drug's effect. The interactome incompleteness can potentially explain the current limitations of network-based drug-disease proximity. Yet, given that the lack of efficacy is the leading reason for failure in drug development, we suspect that the drugs we fail to identify in the proximity of the disease might not be as effective as others. To investigate whether proximity could explain drug efficacy we compile three data sets: (i) Off-label treatments: For each known drug-disease pair, we retrieve the label information from DailyMed and search for the disease in the indication field. If the disease is not mentioned in the indication field we mark this drug-disease association as off-label use (and label use otherwise), resulting in 133 off-label drug-disease associations. (ii) Palliative treatments: For each label use, we check whether the indication field in DailyMed contains any statement referring to the non-causative use of the drug in that disease (for example, manage, relieve, palliate and so on), yielding 50 palliative drug-disease pairs in which the drug relieves the symptoms of the disease. We mark the remaining 219 drug-disease pairs as non-palliative. (iii) Drug efficacy information: We use side effect and efficacy reports from FDA Adverse Event Reporting System and consider 204 drug-disease pairs associated with at least 10 reports. We count the number of entries for the most commonly observed adverse event and the number of entries reporting that the drug was ineffective. The relative efficacy (RE) score is one minus the ratio of the number of drug ineffective reports to the number of reports with the most common adverse reaction. To confirm that RE captures the palliative nature of drugs, we check the distribution of RE scores of manually curated palliative and the remaining known drug-disease pairs (see FIG. 15a), finding that RE scores are significantly lower for palliative drug-disease pairs (one-sided Mann-Whitney U test P=7.3×10⁻⁵ compared with the distribution of RE scores of non-palliative uses and P=7.6×10⁻⁴ compared with that of off-label uses).

Next, we check whether interactome-based proximity can distinguish palliative from non-palliative and off-label drug-disease pairs, observing a significantly lower proximity for drug-disease pairs not described as palliative in DailyMed (FIG. 15b, P=4.0×10⁻⁵ and P=0.02 for non-palliative and off-label uses, respectively). Given that the description for palliative drug-disease pairs in DailyMed is likely to be incomplete and the non-palliative drug-disease pairs likely include palliative drugs as well, the observed segregation of the palliative and the remaining pairs is striking. Moreover, the lower proximity of off-label uses compared with palliative uses suggests that the current ‘wisdom of the crowd’ (off-label treatments recommended by physicians) include promising treatments, most of which likely to be more effective than palliative treatments.

Finally, we explore the distribution of RE scores among proximal and distant drug-disease pairs, finding significantly higher RE scores for proximal drugs (FIG. 15c, P=0.04). These findings indicate that proximity is a good measure of a drug's efficacy in the clinic: proximal drugs are more likely to be therapeutically beneficial than distant drugs that usually correspond to palliative treatments.

Treatment Bottlenecks

To illustrate the utility of the developed framework, next we identify diseases in which proximity successfully pinpoints the drugs prescribed for the disease. The percentage of drugs that are proximal to their indicated disease varies substantially over the 78 diseases. When we look at the 29 diseases for which there are at least five known drugs, we see that most drugs used for asthma, Alzheimer's disease (AD), cardiac arrhythmias, cardiovascular diseases, diabetes, epilepsy, hypersensitivity, kidney diseases, liver cirrhosis, systemic lupus erythematosus, and ulcerative colitis are proximal to the disease (see FIG. 15d, top panel). Similarly, among antineoplastic agents, the drugs used for prostate cancer, breast cancer, and lymphoma tend to be proximal to the indicated diseases. Given that AD, breast cancer, heart diseases and diabetes are prevalent in developed countries, they have been at the center of attention of pharmaceutical companies, potentially explaining the success of the treatments. On the other hand, diseases for which the drugs are distant often involve a substantial inflammatory component, like Crohn's disease, psoriasis and rheumatoid arthritis, suggesting that most of the drugs used in these immune-system-related diseases manage the inflammation or relieve the symptoms of the disease. We also observe that most drugs used in parkinsonian disorders are generally not proximal to the disease. Indeed, for these diseases the RE values are substantially lower compared with the rest of the diseases, confirming that the drugs are more likely to be palliative (see FIG. 15d, bottom panel).

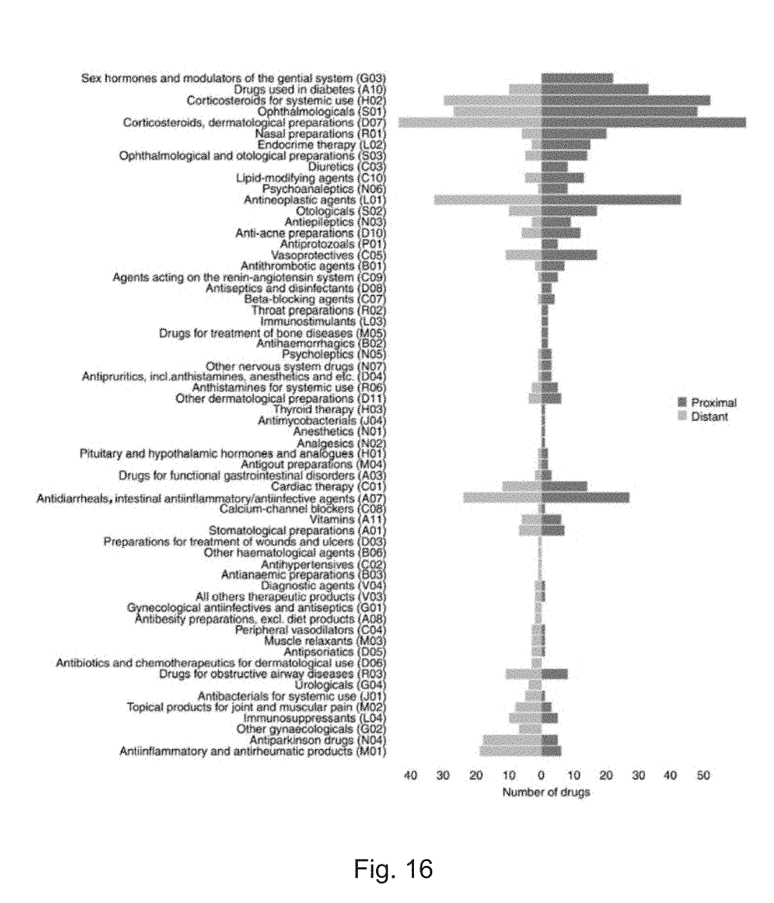

To investigate whether certain groups of drugs are more likely to be proximal to the diseases, we further check their anatomic therapeutic chemical classification (see FIG. 16). Again, we find that proximal drugs tend to involve more mechanistic interventions involving the endocrine system and metabolic processes, whereas distant drugs are more enriched in anti-inflammatory and pain relief related categories.

Uncovering Therapeutic Links Between AD and T2D

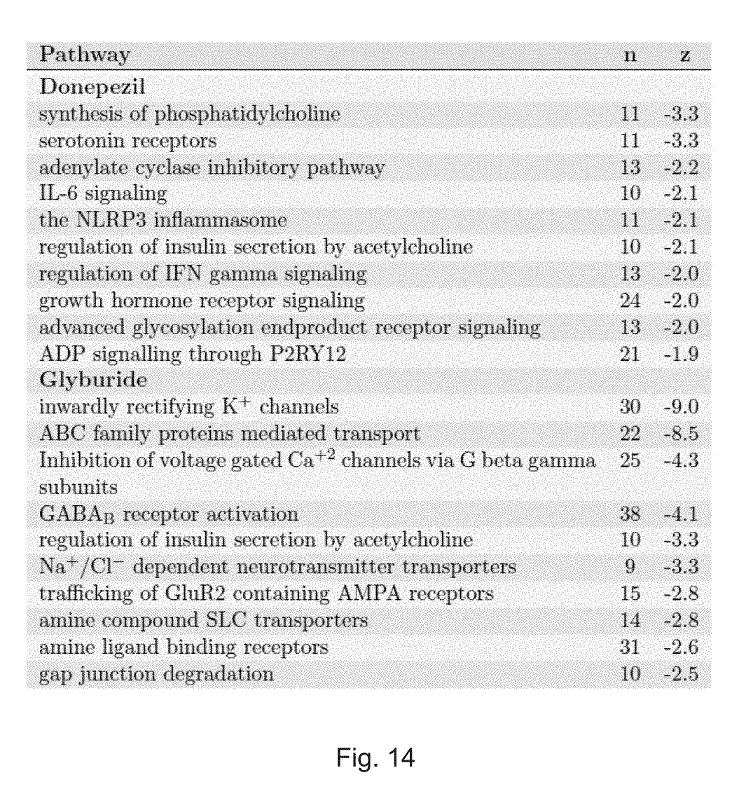

Developing effective treatment strategies for diseases requires an understanding of the underlying mechanism of drug action. Next, we show that the network-based proximity can provide insights into the mechanism of action of glyburide and donepezil, two drugs used in T2D and AD, respectively, revealing therapeutic links between these two diseases. Using the pathway information in Reactome database, we identify the pathways that are proximal to these drugs. Consistent with the known mechanism of action of glyburide, we find pathways related to the regulation of potassium channels and secretion of insulin (see FIG. 14). The drug-pathway proximity also highlights the role of GABAB in regulating G protein receptors during the insulin secretion process.

For donepezil, we find the acetylcholine-related pathway as one of the closest pathways to the drug. Acetylcholinesterase, the known pharmacological action target, catalyses the hydrolysis of acetylcholine molecules involved in synaptic transmission. In addition to the acetylcholine-related pathway, other closest Reactome pathways to donepezil include serotonin receptors′, ‘phosphatidylcholine synthesis’, ‘adenylate cyclase inhibitory pathway’, ‘IL-6 signalling’ and ‘the NLRP3 inflammasome’, thus providing an enhanced view of donepezil's action (see FIG. 14). Indeed, a recent study confirms the fundamental role of NLRP3 in the pathology of AD in mice, offering further insights into how donepezil exerts its therapeutic effect in AD patients. Interestingly, the ‘regulation of insulin secretion by acetylcholine’ is among the closest pathways for both drugs. T2D and AD are known to share a common pathology and exhibit increased co-morbidity. In fact, repurposing anti-diabetic agents to prevent insulin resistance in AD has recently gained substantial attention.

Dissecting Therapeutic Benefits from Adverse Effects

Proximity helps us understand relationships between drugs and diseases and discover novel associations. We first highlight several potential repurposing candidates predicted by proximity among unknown drug-disease pairs. One such candidate is nicotine, a drug originally indicated for ulcerative colitis, which is closer to AD (z_{c}=−1.2) than its original indication. Indeed, nicotine has recently been argued to improve cognition in people with mild cognitive impairment, a symptom that often precedes Alzheimer's dementia. Not surprisingly, the closest pathways to nicotine are acetylcholine-related pathways such as ‘acetylcholine binding and downstream events’, ‘highly calcium permeable postsynaptic nicotinic acetylcholine receptors’ and ‘presynaptic nicotinic acetylcholine receptors’, closely related to the pathways proximal to donepezil, the AD drug above.

We also find that glimepiride and tolbutamide, two T2D drugs that lower blood glucose by increasing the secretion of insulin, are proximal to cardiac arrhythmia (z_{c}=−3.6 and z_{c}=−2.3, respectively). However, these drugs have recently been suggested to induce adverse cardiovascular events. Therefore, network-based proximity does not always imply that the drug will improve the corresponding disease. To the contrary, some drugs may even induce the disease phenotype by perturbing the functions of the proteins in the proximity of the disease module. To distinguish between a novel treatment and a potential adverse effect, we check the proximity of these drugs to the protein sets predicted to induce the side effects. The proteins inducing a given side effect are predicted based on whether they appear significantly as the targets of drugs with the side effect compared with the targets of drugs without the side effect. Although glimepiride and tolbutamide are proximal to the cardiac arrhythmia disease proteins in the network, they are also proximal to the proteins inducing arrhythmia (z_{c}^{side effect}=−1.9 and z_{c}^{side effect}=−1.0, respectively). In line with earlier findings, proximity indicates that their use by patients with cardiovascular problems requires caution.

Next, we provide interactome-based insights to the drug's action in some recent repurposed uses and clinical failures (see Table 1). For instance, we find that proximity can explain why plerixafor, a drug developed against HIV to block viral entry in the cell that failed to meet its end point, is repurposed for non-Hodgkin's lymphoma. We identify that the proximity of plerixafor to the non-Hodgkin's lymphoma disease proteins is z_{c}=−2.4. On the other hand, when we look at the proximity of tabalumab and preladenant, two drugs failed during clinical trials due to lack of efficacy for systemic lupus erythematosus and parkinson disease, respectively, we observe that these drug-disease pairs are more distant than expected for a random group of proteins in the interactome (z_{c}>0). Another recent failure is semagacestat, an AD drug that was found to worsen the condition. Semagacestat is proximal to AD proteins in the interactome (z_{c}=−5.6), indicating that the drug should affect the disease. We are not able to predict the direction of the drug's effect (that is, beneficial or harmful), as there is no protein significantly associated with AD as a side effect. In the case of terfenadine, an antihistamine drug used for the treatment of allergic conditions, however, we find the drug to be proximal to both the cardiac arrhythmia disease proteins (z_{c}=−2.2) and the proteins predicted to induce arrhythmia (z_{c}^{side effect}=−2.6) explaining its withdrawal from markets worldwide.

Finally, using proximity, we provide potential repurposing candidates for 2,947 rare diseases retrieved from orpha.net. Rare diseases are often ignored by pharmaceutical companies due to the small percentage of the population affected and conventional methods are typically unable to offer any candidates. We believe that the proximity-based predictions can provide promising reuses. We note, however, that these predictions need to be validated in the clinic before they can be recommended.

Discussion

Disease phenotypes are typically governed by defects in multiple genes whose concurrent and aberrant activity is necessary for the emergence of a disease. These disease genes are not randomly distributed in the interactome, but agglomerate in disease modules that correspond to well-defined neighborhoods of the interactome. Here, we introduce a computational framework to quantify the relationship between disease modules and drug targets using several distance measures that capture the network-based proximity of drugs to disease genes. The systematic analysis of a large set of diseases shows that drugs do not target the disease module as a whole but rather aim at a particular subset of the disease module. Moreover, the impact of drugs is typically local, restricted to disease proteins within two steps in the interactome.

Proximity provides insights into the drug mechanism of action, revealing the pathobiological components targeted by drugs and increases the applicability and interpretability for repurposing existing drugs. We find that if a drug is proximal to the disease, it is more likely to be effective than a distant drug. We argue that for diseases in which the drugs are distant, the drugs alleviate the symptoms of the disease. We observe that off-label treatments are at least as effective as palliative uses mentioned in the label, providing an interactome-level support for off-label uses of drugs. We use adverse event reports collected by FDA to offer evidence that many disorders involving immune response are indeed targeting the disease symptoms. We also demonstrate several proof-of-concept examples in which proximity successfully predicts both the therapeutic and the adverse effects of known drugs.

We also used proximity to define similarity between two drugs and showed that proximity performed at least as good as existing similarity-based approaches and covered larger number of drug-disease associations. Nevertheless, similarity-based methods can only predict drugs for diseases that already have a drug, therefore are ineffective for drugs that do not share any target with existing drugs or for diseases without known drugs, as it is the case for many rare diseases. Furthermore, these approaches typically do not offer a mechanistic explanation of why a drug would (or would not) work for a disease. On the other hand, proximity enables us to suggest candidate drugs to be repurposed in rare diseases.

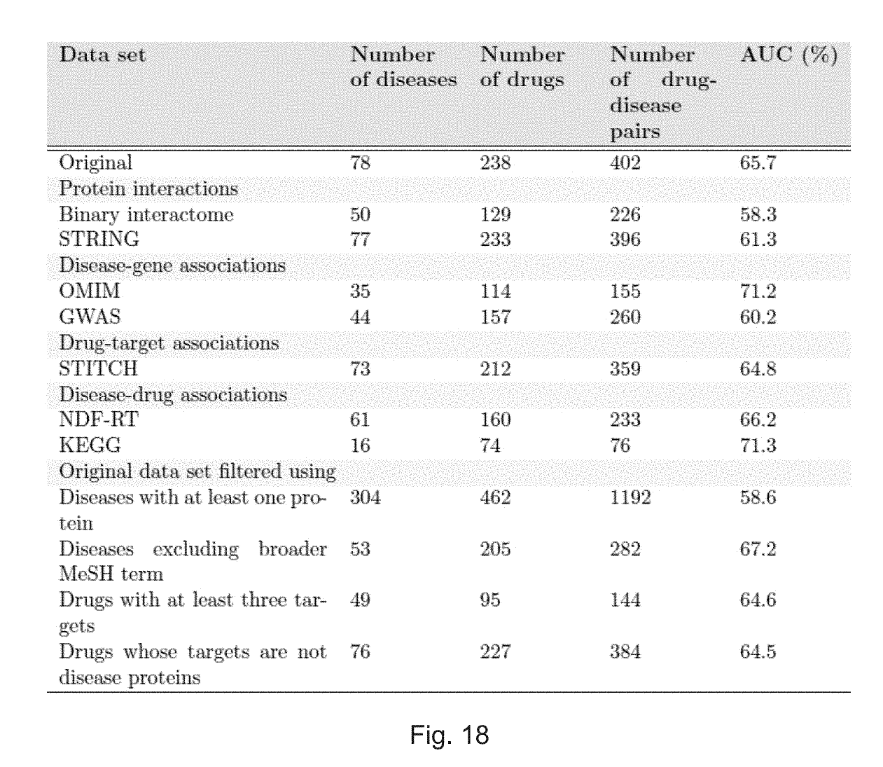

Given the limitations of the current interactome maps, from incompleteness to investigative biases, we have explored how the number and the centrality of drug targets and disease proteins influence their network-based proximity. We find that proximity is not biased with respect to either the number of targets a drug has or their degrees. Thus, proximity corrects a common pitfall in existing studies that do not account for the elevated number of interactions of drug targets. Moreover, we find that the integrated interactome used in this study captures the therapeutic effect of drugs better than both functional associations from STRING database and protein interactions from high-throughput binary screens, two interactome maps widely used in the literature (see FIG. 18). A potential drawback of proximity is that it relies on known disease genes, drug targets and drug-disease annotations, all of which are known to be far from complete. Although we ensure that the annotations used in the analysis are of high quality using various control data sets (see FIG. 18 and Supplementary Note 6) the coverage of our analysis can be increased as more data become available. Furthermore, the directionality of the drug's predicted effect (for example, whether it is beneficial or harmful) depends on the characterization of the proteins inducing the disease, information that is currently limited to only a small subset of the diseases.

Overall, our results indicate that network-based drug-disease proximity offers an unbiased measure of a drug's therapeutic effect and can be used as an effective and holistic tool to identify efficient treatments and distinguish causative treatments from palliative ones. While proximity can provide a systems level explanation towards the drug's effect via quantifying the separation between the drug and the disease in the interactome, understanding the therapeutic effect of drugs at the individual level (that is, patients with different genetic predisposition) requires incorporating large scale patient level data such as electronic health records and personal genomes and remains the goal of future work in this area. It would also be interesting to extend the analysis presented here to drug combinations, in which the proximity of the targets of the combination is likely to be different than the average proximity of the drugs individually, potentially giving insights into the synergistic effects.

Methods

Drug, Disease and Interaction Data Sets

The disease-gene data relied on (Menche, J. et al. “Uncovering disease-disease relationships through the incomplete interactome.” Science 347, 1257601 (2015)) defines diseases using MeSH. Disease-gene associations were retrieved from OMIM and GWAS catalog using UniProtKB and PheGenI, respectively. Only the genes with a genome-wide significance P value <5.0×10⁻⁸ were included from PheGenI. We used only the diseases for which there were at least 20 known genes in the interactome. This cutoff based on number of disease genes ensures that the diseases are genetically well characterized and are likely to induce a module in the interactome. For each disease, we looked for information on FDA approved drugs in DrugBank (downloaded on July 2013) and matched 79 of these diseases with at least one drug using MEDI-HPS (using MEDI_01212013_UMLS.csv file) and Metab2Mesh (retrieved from metab2mesh.ncibi.org on June 2014). MEDI-HPS contains drug-disease associations compiled from RxNorm, MedlinePlus, SIDER, and Wikipedia. We considered a drug to be indicated for a disease if and only if the and there was a strong association based on text-mining in Metab2Mesh (Q value <1.0×10⁻⁸), yielding 337 drugs. We excluded 99 drugs that either had no known targets in the interactome or had the same targets as another drug used for the same disease, resulting in a total of 238 unique drugs and 384 targets. Note that we only considered the pharmacological targets (Targets' section in DrugBank), excluding the enzymes, carriers and transporters that were typically shared among different drugs. To ensure the quality of the drug-disease associations, we downloaded label information for each of these drugs from DailyMed (dailymed.nlm.nih.gov) and checked the indication field. For each drug, we first matched the drug name (and synonyms if there was no match) in the Rx_norm_mapping file and fetched the drug's structured product labeling id(s). We then queried DailyMed using the structured product labelling id. We noticed that Felbamate was incorrectly annotated to be used for aplastic anaemia in MEDIHPS while it was a clear contraindication for this disease. Accordingly, we removed aplastic anaemia from the analysis as there were no other drugs associated with it. For calculating enrichment of proximal drug-disease pairs in clinical trials, we retrieved information on the drugs and the diseases they were tested for from clinicaltrials.gov.

We took the human protein-protein interaction (PPI) network compiled by Menche et al. that contained experimentally documented human physical interactions from TRANSFAC, IntAct, MINT, BioGRID, HPRD, KEGG, BIGG, CORUM, PhosphoSitePlus, and a large scale signaling network. We used the largest connected component of the interactome in our analysis, consisting of 141,150 interactions between 13,329 proteins. ENTREZ Gene IDs were used to map disease-associated genes to the corresponding proteins in the interactome. The interactome and disease-gene association data is provided as a supplementary data set in Menche et al.

To calculate proximity of drugs for rare diseases, we downloaded 3,323 diseases and genes associated with them from orpha.net. For each disease gene, we mapped the Uniprot ID to Gene ID using the external reference field in the XML file and filtered for only the diseases that had at least a known disease protein in the interactome, yielding 2,947 diseases. We then calculated the proximity between each FDA approved drug and the disease. The drugs that did not have any targets in the interactome or that had the same targets as another drug were excluded.

Network-Based Proximity Between Drugs and Diseases

The proximity between a disease and a drug was evaluated using various distance measures that take into account the path lengths between drug targets and disease proteins. Given S, the set of disease proteins, T, the set of drug targets, and d(s,t), the shortest path length between nodes s and t in the network, we define:

$$\begin{matrix}Closest \text{:} {d}_{c} ( S , T ) = \frac{1}{‖ T ‖} {\sum }_{t ∈ T} {min}_{s ∈ S} d ( s , t ) & ( 1 ) \\ Shortest \text{:} {d}_{s} ( S , T ) = \frac{1}{‖ T ‖} {\sum }_{t ∈ T} \frac{1}{‖ S ‖} {\sum }_{s ∈ S} d ( s , t ) & ( 2 ) \\ Kernel \text{:} {d}_{k} ( S , T ) = \frac{- 1}{‖ T ‖} {\sum }_{t ∈ T} ln {{\sum }_{s ∈ S}}^{\frac{{e}^{- ( d ( s , t ) + 1 )}}{‖ S ‖}} & ( 3 ) \\ Centre \text{:} {d}_{cc} ( S , T ) = \frac{1}{‖ T ‖} d ( {centre}_{s} , t ) & ( 4 )\end{matrix}$$

where centreS, the topological centre of S was defined as

$${centre}_{s} = arg {min}_{u ∈ S} {\sum }_{s ∈ S} d ( s , u )$$

in case the centreS is not unique, all the nodes are used to define the centre and the shortest path lengths to these nodes are averaged.

$$Separation : {d}_{m} ( S , T ) = dispersion ( S , T ) - \frac{{d}_{c}^{′} ( S , S ) + {d}_{c}^{′} ( T , T )}{2} \qquad ( 5 )$$

where dispersion

$$( S , T ) = \frac{‖ T ‖ {d}_{c} ( S , T ) ‖ S ‖ {d}_{c} ( T , S )}{‖ T ‖ + ‖ S ‖}$$

and d′_{c} is the modified closest measure in which the shortest path length from a node to itself is infinite.

To assess the significance of the distance between a drug and a disease (T,S), we created a reference distance distribution corresponding to the expected distances between two randomly selected groups of proteins matching the size and the degrees of the original disease proteins and drug targets in the network. The reference distance distribution was generated by calculating the proximity between these two randomly selected groups, a procedure repeated 1,000 times. The mean μ_{d(S,T)} and standard deviation σ_{d(S,T)} of the reference distribution were used to convert an observed distance to a normalized distance, defining the proximity measure:

$$z ( S , T ) = \frac{d ( S , T ) - {μ}_{d ( S , T )}}{{σ}_{d ( S , T )}}$$

due to the scale-free nature of the human interactome, there are few nodes with high degrees. To avoid repeatedly choosing the same (high degree) nodes during the degree-preserving random selection, we used a binning approach in which nodes within a certain degree interval were grouped together such that there were at least 100 nodes in the bin. Accordingly, each bin B_{i,j} was defined as B_{i,j}={uεV|i≦kᵤ<j} containing the nodes with degrees i to minimum possible j such that ∥B_{i,j}∥≧100.

Area under ROC curve and optimal proximity cutoff analysis. We used AUC to evaluate how well the distance measures discriminated known drug-disease pairs from unknown drug-disease pairs. Given a set of known drug-disease associations (positive instances) and a set of drug-disease couplings in which the drug is not expected to work on the disease (negative instances), the true positive rate and false positive rate were calculated at different thresholds to draw the ROC curve. The area under this curve was computed using the trapezoidal rule. While known drug-disease associations can be used as positive control, defining the negative control (drugs that have no effect on a disease) is not straightforward. As a proxy, we assumed that all unknown drug-disease associations were negatives, thereby ignoring potential positive cases among the unknown associations. Furthermore, to control for the size imbalance of known and unknown drug-disease associations, we randomly chose 402 pairs among unknown drug-disease associations and used them as negatives in the AUC calculation. We repeated this procedure 100 times and used the average of the AUC values to compare the distance measures (see FIG. 11). Again, the AUC values were consistent with what we observed using all unknown drug-disease pairs as negatives, pointing out the robustness of drug-disease proximity against negative data selection. In both models, the closest measure discriminates best the known drug-disease associations from the random drug-disease associations, as it was observed using all unknown drug-disease pairs as negatives.

To find the optimal network-based proximity threshold (z_{c}^{threshold}) for which a drug was more likely to work on (proximal to) a certain disease, we used proximity versus sensitivity and specificity curves. Sensitivity corresponds to the percentage of the positive (known) drug-disease associations that are found proximal among all positive drug-disease associations. Specificity corresponds to the percentage of the negative (unknown or random) drug-disease associations that are not proximal among all negative drug-disease associations. Accordingly, the network-based proximity threshold, z_{c}^{threshold}, giving both high coverage (assessed by sensitivity) and low number of false positives (assessed by 1−specificity) was defined as the value at which the sensitivity and specificity curves intersected (see FIG. 11). In our analysis, we set z_{c}^{threshold}=−0.15, that is, a drug was defined to be proximal to a disease if the proximity between them was ≦0.15. To ensure the robustness of z_{c}^{threshold,} we repeated the analysis on two other data sets and showed that the z_{c}^{threshold} value was similar (see Supplementary Note 5). In addition to sensitivity and specificity, we provide F-score (harmonic mean of precision and sensitivity) measures at different proximity cutoffs. A different cutoff value can be used to define proximity depending on the desired coverage and false positive rate.

Evaluating the Therapeutic Effect of Drugs

We annotated the drug-disease associations based on whether the label information in DailyMed contained the drug-disease association given in MEDI-HPS. Accordingly, we marked 269 drug-disease associations appearing in the label as label use and the remaining 133 drug-disease associations as off-label use. We also looked for statements referring to the non-causative use of the drug in that disease in the DailyMed indication field. We specifically searched for sentences containing the following keywords and their variations: ‘palliative’, ‘symptomatic’, and ‘signs and symptoms’. We required that the disease the drug was used for was unambiguously mentioned in the indication field. This data set contained 50 of 402 known drug-disease pairs in which the drug was used to manage the signs and symptoms of the disease.

We compiled drug efficacy information using the adverse event reports submitted to FDA Adverse Event Reporting System. A report lists the patient reaction for a given drug and disease including ‘pain’, ‘nausea’, and ‘drug ineffective’ among many other reactions. We used openFDA Application Programming Interface (api.fda.gov/drug) to retrieve the adverse reaction information and considered only 204 drug-disease pairs for which there were at least 10 adverse event reports for the most common adverse reaction. We counted the number of reports containing the ‘drug ineffective’ reaction (n_{inefficient}) and derived a score, RE, by comparing it with the number of most occurring reaction (nₜₒₚ) for that drug-disease pair. The RE is defined as the complement to one of relative inefficacy, where relative inefficacy is the ratio of the number of ‘drug ineffective’ reports to the number of most common adverse event reports. Hence,

$$RE = 1 - \frac{{n}_{inefficient}}{{n}_{top}}$$

The RE takes values between 0 (poorest efficacy, ‘drug ineffective’ reports are the most common reports) and 1 (there is no ‘drug ineffective’ report associated with this drug-disease pair). For instance, among the reports containing atorvastatin and arteriosclerosis, ‘myalgia’ was the most common reaction with 13 occurrences and there were two reports containing ‘drug ineffective’, yielding RE=0.85. When multiple drugs are reported in the same entry, the observed reactions may not be due to all drugs. Nevertheless RE still provides a reasonable proxy for the efficacy of the drug. In addition to the drug names provided in DrugBank, synonyms and brand names were queried through the API and the query returning the most results was chosen to represent the drug and used in further queries fetching reactions. The disease names were also modified to match the names used in the openFDA data set.

Network-Based Pathway and Side-Effect Proximity Analysis

To identify the biological pathways affected by a drug in the human interactome, we used the closest measure to quantify the proximity between drugs and pathways. The drug-pathway proximity is the normalized distance calculated between the drug targets and proteins belonging to a given pathway. Similar to drug-disease proximity, randomly selected protein sets matching the original protein sets in size and degrees were used to calculate the mean and the standard deviation for the z-score calculation. We used all Reactome pathways provided in MsigDB that had at most 50 proteins (as larger pathways tend to describe broader biological processes) and ranked all the pathways with respect to their proximity to a given drug.

To check whether a drug was proximal to the proteins inducing certain side effects, we first defined the protein sets inducing side effects and then calculated the network-based proximity of drug targets to these proteins. The side-effect proteins were identified using a Fisher's test-based enrichment analysis. Accordingly, for each side-effect reported for at least five drugs in SIDER and for each target of these drugs, we counted the number of drugs that the side effect and drug-target appeared together as well as the number of drugs in which they appeared individually (only side effect or only drug) and did not appear at all together. We then corrected the two-sided P value for multiple hypothesis testing using Benjamini and Hochberg's method to decide whether a drug-target induced a certain side effect. For each side effect, the targets <20% false discovery rate were predicted to induce the side effect. For each of the 78 diseases in the data set, we manually mapped the MeSH disease terms to SIDER side-effect terms where available (58 out of 78 diseases) and used 17 side effects that had at least one predicted protein.

Statistical Tests and Code Availability

We used Fisher's exact test and two-sided P values associated with it to evaluate the strength of the enrichment of proximal drug-disease pairs among known and unknown drug-disease pairs. The alpha value for the significance of P values was set to 0.05. For assessing difference between means of distribution of RE values, one-sided Mann-Whitney U test was used with the same alpha value as before. The alternative hypotheses for the one-sided test were (i) the palliative drugs were expected to have lower RE values, (ii) the palliative drugs were expected to have larger proximity values, and (iii) the proximal drugs were expected to have higher RE values. We used R (r-porject.org) for statistical tests and data visualization and Python (python.org) to parse various data sets and to calculate drug-disease proximity (see toolbox package located at github.com/emreg00/toolbox).

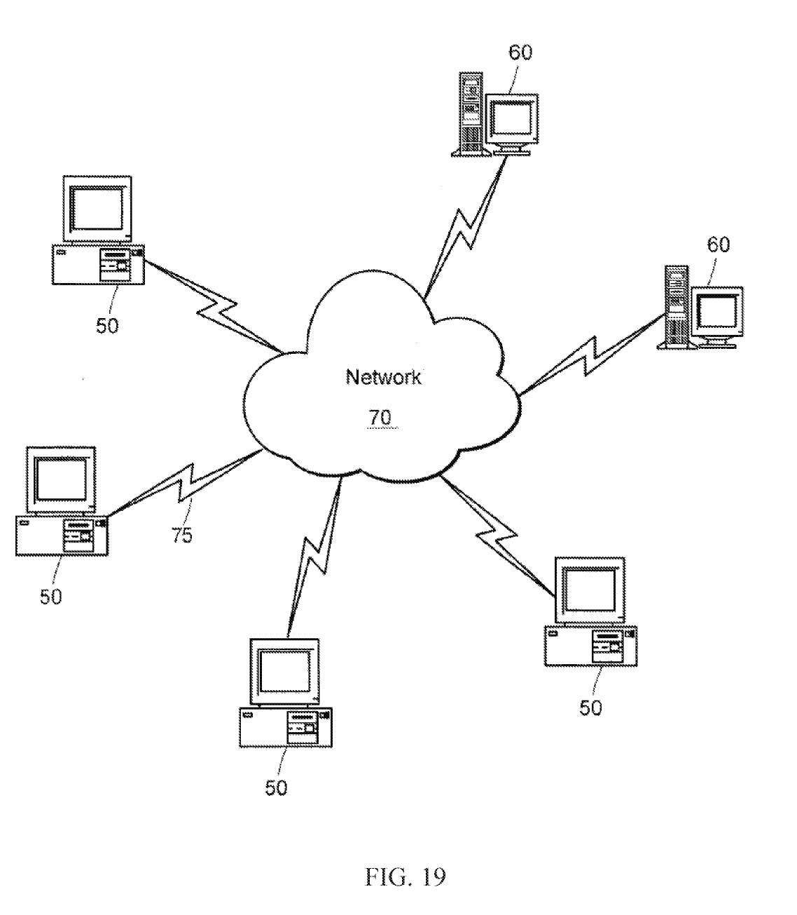

FIG. 19 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60, via communication links 75 (e.g., wired or wireless network connections). The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

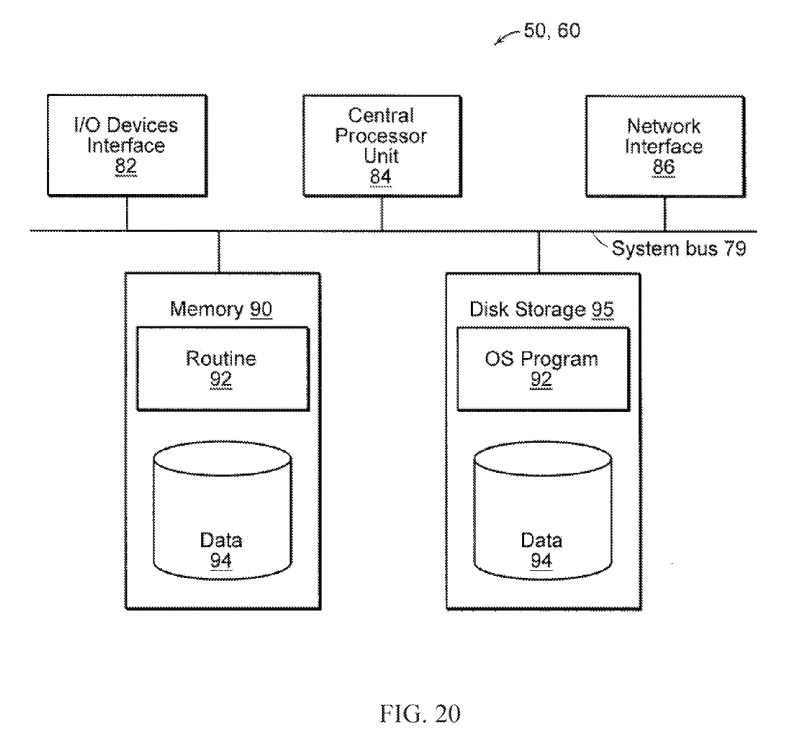

FIG. 20 is a diagram of an example internal structure of a computer (e.g., client processor/device 50 or server computers 60) in the computer system of FIG. 19. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 16). Memory 90 provides volatile storage for computer software instructions 92 and data 94 used to implement an embodiment of the present invention. Disk storage 95 provides non-volatile, non-transitory storage for computer software instructions 92 and data 94 used to implement an embodiment of the present invention (e.g., the example methods 100, 200, 300, 400, 500 of FIGS. 1-5 and the example system 600 of FIG. 6). A central processor unit 84 is also attached to the system bus 79 and provides for the execution of computer instructions. The disk storage 95 or memory 90 can provide storage for a database. Embodiments of a database can include a SQL database, text file, or other organized collection of data. In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

Supplementary Note 1—Drugs target two-step neighborhood of the disease genes. To pinpoint drug-disease associations even when the target is not a disease protein, we defined the drug-disease proximity using several network-based distance measures. We observe that the closest measure captures the drug-disease proximity better than the remaining measures, suggesting that drug targets do not necessarily have to be close to all the proteins in the disease module. Motivated by this observation, we test the performance of the network-based proximity using only (i) disease proteins at most l steps away from a drug target (seed subset), (ii) the drug targets at most l steps away from a disease protein (target subset), (iii) the drug target and disease protein pairs that are at most l steps away from each other (target-seed subset). Note that the seed and target subset approaches are not symmetric: Given a set of drug targets T={t₁, t₂} and a set of disease proteins S={s₁, s₂}, say while the closest disease protein to the drug target t₁ is s₁, the closest drug target to s₁ might be t₂ but not t₁. To restrict the distance calculation to a given distance l, we first calculate the shortest path distances between each pair of drug target (tᵢ) and disease protein (sⱼ), sort these distances and then consider only the pairs (tᵢ, sⱼ) for which d(tᵢ, sⱼ)≦1.

Through exhaustive search of parameter space (lε{0, 1, 2, 3, 4}), we find that the AUC does not change significantly after l=2 (see FIG. 9a). Furthermore, the AUC at l=2 is comparable to AUCs when all disease genes or all drug targets are considered. Indeed, the distribution of distances between drug targets and disease proteins among known drug-disease pairs shows that 90% of the drugs have a known disease protein within two steps (see FIG. 9b). This suggests that most drugs exert their therapeutic effect on the disease proteins that are at most two steps away.

Supplementary Note 2—Proximity does not depend on the number and degree of drug targets and disease proteins. Several factors such as the number and degree of the drug targets and disease proteins can influence the discriminatory performance of the drug-disease proximity measure. Drugs with more targets or whose targets are more central are expected to be closer to a disease protein (and vice versa). To check whether proposed proximity measure is biased towards such drugs, we plot proximity versus number of drug targets and degree of drug targets among all possible drug-disease associations. We find that both number of targets of a drug and the average degree of the drug's targets show almost no correlation with proximity (Spearman's rank correlation coefficient, FIGS. 10a and 10b, p=0.08, P=9.6×10⁻³¹ and p=−0.10, P=1:9×10⁻⁴⁶, respectively). Similarly, the drug-disease proximity is not correlated with either the number of disease proteins (FIGS. 10c and 10d, p=−0.01, P=0.12), or the average degree of disease proteins (p=0.03, P=3.1×10⁻⁵).

Supplementary Note 3—Proximity and drug similarity based repurposing. Drug-drug similarity is often used to predict a novel use for a given drug. The similarity between two drugs is usually defined based on sharing chemical structure, targets, functional annotations (of the targets), or side effects as well as shortest path distance between targets in the interactome. Accordingly, given two drugs X and Y with targets T_{X} and T_{Y}, we calculate:

(i) the interactome-based distance between the targets of X and Y:

δ_{target PPI}(X,Y)=e^{-l(X,Y)}

where l(X, Y) is defined as

$$l ( X , Y ) = \frac{{\sum }_{u ∈ {T}_{X} , v ∈ {T}_{Y}} d ( u , v )}{‖ {T}_{X} ⋃ {T}_{Y} ‖}$$

and d(u, v) denoting the shortest path distance between proteins (u, v) in the interactome. Accordingly, two drugs X and Y are similar if their targets are close to each other in the interactome. For defining proximity-based similarity, we use z_{c}(X, Y) instead of l(X, Y).

(ii) the ratio of common drug targets of X and Y:

$${δ}_{target} ( X , Y ) = \frac{{\sum }_{t ∈ {T}_{X} ⋂ {T}_{Y}} {w}_{t}}{‖ {T}_{X} ⋃ {T}_{Y} ‖}$$

where wₜ, the disease-specificity of each target (the number of diseases for which a drug with target t is used), is given by

$${u}_{t}^{′} = \frac{1}{{\sum }_{i ∈ D} {I}_{i}^{t}}$$

with D being all the diseases analyzed in this study and Iᵢ^{t} being an indicator variable defined as

$${I}_{i}^{t} = \{ \begin{matrix}1 , & t is targeted by a drug used for disease i \\ 0 , & otherwise\end{matrix}$$

That is, the similarity between drugs X and Y is based on the number and disease-specificity of their shared targets. Note that if wₜ=1 for all targets, the similarity reduces to the Jaccard index of the targets of X and Y ignoring whether the targets are disease-specific or not.

(iii) chemical similarity between X and Y:

$${δ}_{chemical} ( X , Y ) = \frac{‖ {F}_{X} ⋀ {F}_{Y} ‖}{‖ {F}_{X} ⋁ {F}_{Y} ‖}$$

where F_{X}, F_{Y} are 2D SMILES fingerprints of drug X and Y, respectively. That is, the chemical similarity of drugs X and Y is defined as the Tanimoto index of the SMILES fingerprints of X and Y. We first converted the SMILES fingerprints to aromatic form and then calculated Tanimoto index using Indigo Python toolkit (lifescience.opensource.epam.com/indigo).

(iv) the ratio of GO terms shared among the targets of X and Y:

$${δ}_{GO} ( X , Y ) = \frac{{\sum }_{m ∈ {M}_{X} ⋂ {M}_{Y}} {w}_{m}}{‖ {M}_{X} ⋃ {M}_{Y} ‖}$$

where M_{X} and M_{Y} are the set of GO molecular function terms annotated for T_{X} and T_{Y}, Respectively and wₘ is the Disease-Specificity of Each Common GO Term m Calculated Based on the number of diseases m appears among the targets of the drugs used for each disease. Thus, δ_{GO}(X, Y) gives the functional similarity of drugs X and Y as the common disease-specific molecular function GO terms. Gene annotations were downloaded from GO web page (geneontology.org/page/downloads) in July, 2013.

(v) the ratio of common side effects of X and Y:

$${δ}_{side effect} ( X , Y ) = \frac{{\sum }_{e ∈ {E}_{X} ⋂ {E}_{Y}} {e}_{m}}{‖ {E}_{X} ⋃ {E}_{Y} ‖}$$

where E_{X} and E_{Y} are known side effects of drugs X and Y, respectively and we is the disease-specificity of each common side effect e calculated based on the number of diseases for which a drug with e exists. The side effects of drugs are retrieved using SIDER database. The drugs are mapped to each other via the PubChem identifiers provided in DrugBank and SIDER databases.

(vi) the perturbation profile similarity of X and Y:

$${δ}_{LINCS} ( X , Y ) = \frac{‖ {P}_{X} ⋂ {P}_{Y} ‖}{‖ {P}_{X} ⋃ {P}_{Y} ‖}$$

corresponding to the ratio of common differentially regulated genes in the perturbation profiles of X and Y in LINCS database located at lincsproject.org where P_{X} and P_{Y} are the gene sets that are differentially expressed upon perturbation by drugs X and Y, respectively. The differentially expressed 100 landmark genes (lm 100) upon drug perturbations were retrieved using LINCS API in June, 2014 (api.lincscloud.org) and in case of multiple perturbations for the same drug (i.e., multiple cell lines, perturbation times or dosages), the perturbations resulting in highest similarity (δ_{LINCS}(X, Y)) are used.

Although predicted side effects, drug targets or disease-disease similarity information can increase the coverage of these methods, their use is likely to have a significant impact on the prediction performance due to the limited reliability of available prediction methods. Furthermore, it is not possible to discover novel drugs whose targets have not been explored for a particular disease or to find drugs that do not have a certain (e.g., undesired) side effect because of the dependence on the existing drug and disease information. Drug-disease proximity overcomes these limitations, as it does not depend on the existing knowledge of drug-disease associations.

Supplementary Note 4—Comparing proximity to gene expression based repurposing. To identify drugs that can potentially account for the gene expression changes induced by diseases, recent studies proposed using correlation of gene expression between the disease state and after treatment with drug. The premise of these studies is to find drugs whose perturbation profiles are anti-correlated with the genes perturbed in the disease such that the treatment with the drug can revert the expression changes in the disease state. That is, for instance, if a gene is over-expressed in the disease condition, the goal is to find a drug that yields the under-expression of that gene. We test this hypothesis using Drug versus Disease (DvD) R package to correlate drug and disease gene expression profiles from public microarray repositories. DvD provides the precalculated reference ranked gene lists based on differential expression from disease states in Gene Expression Omnibus (GEO, ncbi.nlm.nih.gov/geo) and drug perturbations in Connectivity Map (DrugVsDiseasedata and cMap2data R data packages, respectively). In DvD, disease profiles are defined for 45 diseases based on various data sets in GEO and drug profiles are defined by merging multiple samples for the same compound for 1309 compounds in Connectivity Map version 2. The 200 significantly differentially expressed genes (top and bottom 100 genes in the ranked lists) are used to calculate an enrichment score based on Kolomgorov-Smirnov statistic (i.e., calculateES function in the R package), corresponding to the strength of the anti-correlation of drug and disease profiles. DvD had information for 72 drugs and 14 diseases in our data set covering 95 out of 402 known drug-disease pairs and 1,885 out of 18,162 unknown pairs.

Supplementary Note 5—Robustness of drug-disease proximity threshold. To define proximal and distant drug-disease pairs, we examine the coverage of known and unknown drug-disease associations at various thresholds and choose the threshold, z^{threshold} that gives both high coverage and low false positive rate (Sensitivity and 1−Specificity, respectively) identified by the threshold for which Sensitivity and Specificity have both high values. We use ROCR package to calculate the Sensitivity and Specificity values and then find the cutoff for which these values are equally high (i.e., the difference between the two values are within |Δ|<1%). For the original data set used in the analysis, z^{threshold}=−0.15 with a Sensitivity of 59% and Specificity of 60%.

We confirm that the selected interactome-based proximity threshold does not change significantly by repeating our analyses using drug-disease associations from (i) NDF-RT and (ii) KEGG. On both data sets, we find that the threshold is similar to that of the original data set. We also check the enrichment of known drug-disease pairs among proximal and distant drug-disease pairs to ensure that our findings on the relationship between the proximity and a drug's therapeutic effect generalizes over different data sets. Consistent with the original analysis we find that drugs proximal to a disease are at least 2 times more likely to be effective on that disease in both data sets (Fisher's exact test, OR=2.2, P=4.8×10⁻⁹ using NDF-RT and OR=3.0, P=4.8×10⁻⁶ using KEGG).

Supplementary Note 6—Controlling for data quality. Data incompleteness and study bias pose substantial challenges in the systematic analysis and interpretation of biological data. Current literature provides a snapshot of drugs known to be effective in several diseases, known drug targets, disease genes and protein-protein interactions. To make sure that the drug, disease and interaction data sets used in our analysis constitute an accurate representation of the state-of-the-art, we test the performance of drug-disease proximity measure across different data sets (see FIG. 18).

To evaluate the effect of the underlying network on proximity, in addition to the integrated human interactome (PPI), we use the binary human interactome compiled from high-quality yeast two-hybrid interaction detection screens and literature (Lit-BM-13 and HI-II-14 at interactome.dfci.harvard.edu/H sapiens/host.php). The binary interactome covers 7,544 proteins and 24,202 interactions between them, thus it is much smaller than PPI. The AUC corresponding to discrimination of known and unknown drug-disease pairs drops significantly, indicating that the coverage of the interactome has a significant effect on the drug-disease proximity. Though binary assays provide systematic high-quality data, their coverage is limited. To counterbalance this limitation, we use a functional association network from STRING database containing interactions with a confidence score 700 or higher. The STRING network has 16,086 proteins and 314,656 interactions, more than double the number of interactions in the PPI network. Yet, the AUC is slightly higher than that of binary interactome, suggesting that both the quality and the coverage of the protein interaction data have a significant impact on the proximity between drugs and diseases.

Next, we assess the effect of disease annotations on drug-disease proximity by using only disease gene information from either the OMIM database or the GWAS Catalogue. The AUC using only OMIM data is higher than the original AUC (using both OMIM and GWAS genes), whereas the AUC using only GWAS data is substantially lower. However, among 78 diseases in the original data set, there are 43 diseases that have no associated genes in OMIM database. Therefore, using the data from both OMIM and GWAS substantially increases the coverage of the diseases.

To account for the limitations of drug-target association data, we also use drug target information from STITCH database that integrates known and predicted drug target associations based on evidence in the literature. For each drug, the proteins with confidence score greater than 700 are considered to be targeted by the drug in addition to the targets provided in DrugBank. This data set contains 2,244 distinct targets for 212 drugs. The median number of targets per drug using STITCH is significantly higher (15 targets per drug vs. 2 targets per drug using DrugBank). Nonetheless, the AUC is slightly lower, suggesting that quality of drug-target information is at least as important as the coverage.

To make sure that the drug-disease annotations used in our analysis is of high confidence, in addition to MEDI-HPS, we collect drug-disease associations from National Drug File-Resource Terminology (NDF-RT) and Kyoto Encyclopedia of Genes and Genomes (KEGG). We retrieve the drug-disease associations using NDF-RT (rxnay.nlm.nih.gov/NdfrtAPIs.html) and KEGG (rest.kegg.jp) REST APIs, respectively. In NDF-RT, a drug is considered to be indicated for a disease if and only if the drug's NDF-RT entry contained a “may treat” relationship with the disease. Similar to the drug-disease associations used in the original analysis, we filter these drug-disease associations using Metab2Mesh (q-value <1×10⁻⁸). The AUC is considerably higher using drug-disease associations from KEGG, suggesting that the annotations in KEGG tend to be more reliable. Nonetheless, the number of drugs and diseases included in the analysis is significantly lower compared to the annotations from MEDI-HPS. Hence, MEDI-HPS offers a good compromise between accuracy and coverage of drug-disease associations, allowing us to analyze the most number of drugs and diseases.

We also examine the AUC value for all diseases with one or more corresponding gene, as opposed to restricting to the diseases with at least 20 genes. As expected, the inclusion of these diseases with fewer genes are known lowers the prediction performance, yet it remains significantly higher than the random expectation. Given that the drug disease proximity is not biased with respect to number of disease genes, the drop in the AUC can be attributed to the diseases with less genes being genetically less understood. On the other hand, as several diseases used in the original analysis are broader categories involving more specific conditions, we assess the effect of excluding the broader MeSH disease categories from the analysis (e.g., liver cirrhosis is removed and liver cirrhosis biliary is kept). To do this we identify the disease pairs that have substantial portion of their genes in common (i.e., that have a Jaccard index higher than 0.5) and keep only the specific MeSH term in the MeSH hierarchy (lower in the hierarchy). We observe that the resulting prediction accuracy is comparable to the AUC using all the diseases.

In the original analysis, we assume that the known drug targets are typically the therapeutic targets (for which the drug is intended for). To check whether the analysis depends on the number of targets a drug has, we limit the analysis to those drugs that had at least three targets. In line with our expectation, the AUC does not change substantially compared to using all drugs. Similarly, to confirm that proximity can pick drug-disease associations for drugs whose targets are not disease genes, we repeat the analysis excluding the drug-disease pairs in which all drug targets are also disease genes (d_{c}=0). The AUC values are only slightly lower, suggesting that relative proximity can successfully identify indirect relationships between drugs and diseases.

While this invention has been particularly shown and described with references to example embodiments thereof, it will be understood by those skilled in the art that various changes in form and details may be made therein without departing from the scope of the invention encompassed by the appended claims.

What is claimed is:

1. A method of determining a proximity between a first node group and a second node group in an interaction network, the method comprising:
determining a reachability value between the first node group and the second node group, the reachability value being determined by averaging a shortest path length from each node in the first node group to a closest node in the second node group, the closest node being a node in the second node group that is closest in network distance to the node in the first node group;
selecting a first set of additional node groups in the interaction network, the first set of additional node groups being a plurality of random node groups having nodes with degrees that are similar to the nodes of the first node group;
selecting a second set of additional node groups in the interaction network, the second set of additional node groups being a plurality of random node groups having nodes with degrees that are similar to the nodes of the second node group;
generating a distribution of expected reachability values by determining reachability values for pairs of node groups between the first set of additional node groups and the second set of additional node groups, each reachability value being determined by averaging a shortest path length from each node in one of the node groups of the first set of additional node groups to a closest node in a corresponding node group of the second set of additional node groups; and
determining the proximity between the first node group and the second node group based on (i) the reachability value between the first node group and the second node group, (ii) the mean of the distribution of expected reachability values, and (iii) the standard deviation of the distribution of expected reachability values.

2. A method as in claim 1 wherein:
the interaction network includes representations of biological interactions between proteins, the proteins including drug targets and disease proteins;
the first node group includes representations of drug targets; and
the second node group includes representations of disease proteins.

3. A method as in claim 2 wherein:
selecting the first set of additional node groups includes selecting representations of drug targets having, according to the interaction network, a number of interactions with other proteins that is similar to a number of interactions that the nodes of the first node group have with other proteins; and
selecting the second set of additional node groups includes selecting representations of disease proteins having, according to the interaction network, a number of interactions with other proteins that is similar to a number of interactions that the nodes of the second node group have with other proteins.

4. A method as in claim 2 further comprising determining whether a drug corresponding to the first node group is therapeutically beneficial to a disease corresponding to the second node group based on the determined proximity between the first node group and the second node group.

5. A method as in claim 2 further comprising determining whether a drug corresponding to the first node group is effective for palliative treatment of a disease corresponding to the second node group based on the determined proximity between the first node group and the second node group.

6. A method as in claim 2 further comprising determining a new application of a drug corresponding to the first node group for a disease corresponding to the second node group based on the determined proximity between the first node group and the second node group.

7. A method as in claim 2 further comprising determining a probable adverse side effect of a drug corresponding to the first node group based on a proximity between the first node group and a representation of a protein that is likely to induce the adverse side effect.

8. A method as in claim 7 wherein the protein is determined to be likely to induce the adverse side effect if the representation of the protein is significantly associated with drugs having the adverse side effect compared to drugs not having the adverse side effect.

9. A method as in claim 1 wherein:
the interaction network includes representations of a social network;
the first node group includes representations of a first group of entities in the social network; and
the second node group includes representations of a second group of entities in the social network.

10. A method as in claim 9 further including determining a similarity between the first group of entities and the second group of entities based on the determined proximity between the first node group and the second node group.

11. A system for determining a proximity between a first node group and a second node group in an interaction network, the system comprising:
memory including the interaction network;
a hardware processor in communication with the memory and configured to perform a predefined set of operations in response to receiving a corresponding instruction selected from a predefined native instruction set of codes; and
a control module in communication with the processor and comprising:
a first set of machine codes selected from the native instruction set for causing the hardware processor to determine and store in the memory a reachability value between the first node group and the second node group, the reachability value being determined by averaging a shortest path length from each node in the first node group to a closest node in the second node group, the closest node being a node in the second node group that is closest in network distance to the node in the first node group;
a second set of machine codes selected from the native instruction set for causing the hardware processor to select and store in the memory a first set of additional node groups in the interaction network, the first set of additional node groups being a plurality of random node groups having nodes with degrees that are similar to the nodes of the first node group;
a third set of machine codes selected from the native instruction set for causing the hardware processor to select and store in the memory a second set of additional node groups in the interaction network, the second set of additional node groups being a plurality of random node groups having nodes with degrees that are similar to the nodes of the second node group;
a fourth set of machine codes selected from the native instruction set for causing the hardware processor to generate and store in the memory a distribution of expected reachability values by determining reachability values for pairs of node groups between the first set of additional node groups and the second set of additional node groups, each reachability value being determined by averaging a shortest path length from each node in one of the node groups of the first set of additional node groups to a closest node in a corresponding node group of the second set of additional node groups; and
a fifth set of machine codes selected from the native instruction set for causing the hardware processor to determine and store in the memory the proximity between the first node group and the second node group based on (i) the reachability value between the first node group and the second node group, (ii) the mean of the distribution of expected reachability values, and (iii) the standard deviation of the distribution of expected reachability values.

12. A system as in claim 11 wherein:
the interaction network includes representations of biological interactions between proteins, the proteins including drug targets and disease proteins;
the first node group includes representations of drug targets; and
the second node group includes representations of disease proteins.

13. A system as in claim 12 wherein:
the second set of machine codes causes the hardware processor to select the first set of additional node groups by selecting representations of drug targets having, according to the interaction network, a number of interactions with other proteins that is similar to a number of interactions that the nodes of the first node group have with other proteins; and
the third set of machine codes causes the hardware processor to select the second set of additional node groups by selecting representations of disease proteins having, according to the interaction network, a number of interactions with other proteins that is similar to a number of interactions that the nodes of the second node group have with other proteins.

14. A system as in claim 12 further including an additional set of machine codes selected from the native instruction set for causing the hardware processor to determine whether a drug corresponding to the first node group is therapeutically beneficial to a disease corresponding to the second node group based on the determined proximity between the first node group and the second node group.

15. A system as in claim 12 further including an additional set of machine codes selected from the native instruction set for causing the hardware processor to determine whether a drug corresponding to the first node group is effective for palliative treatment of a disease corresponding to the second node group based on the determined proximity between the first node group and the second node group.

16. A system as in claim 12 further including an additional set of machine codes selected from the native instruction set for causing the hardware processor to determine a new application of a drug corresponding to the first node group for a disease corresponding to the second node group based on the determined proximity between the first node group and the second node group.

17. A system as in claim 12 further including an additional set of machine codes selected from the native instruction set for causing the hardware processor to determine a probable adverse side effect of a drug corresponding to the first node group based on a proximity between the first node group and a representation of a protein that is likely to induce the adverse side effect.

18. A system as in claim 17 wherein the protein is determined to be likely to induce the adverse side effect if the representation of the protein is significantly associated with drugs having the adverse side effect compared to drugs not having the adverse side effect.

19. A system as in claim 11 wherein:
the interaction network includes representations of a social network;
the first node group includes representations of a first group of entities in the social network; and
the second node group includes representations of a second group of entities in the social network.

20. A system as in claim 19 further including an additional set of machine codes selected from the native instruction set for causing the hardware processor to determine a similarity between the first group of entities and the second group of entities based on the determined proximity between the first node group and the second node group.
